(19) United States
(12) Patent Application Publication
(10) Pub. No.: US 2019/0339468 A1
(43) Pub. Date: Nov. 7, 2019

(54) SPARE CHANNELS ON PHOTONIC INTEGRATED CIRCUITS AND IN PHOTONIC INTEGRATED CIRCUIT MODULES AND SYSTEMS

(71) Applicants: Peter W. Evans, Tracy, CA (US); Fred A. Kish, JR., Palo Alto, CA (US); Vikrant Lal, Sunnyvale, CA (US); Jacco Pleumeekers, Mountain View, CA (US); Timothy Butrie, Hellertown, PA (US); David G. Coult, Oley, PA (US); John W. Osenbach, Kutztown, PA (US); Jie Tang, Fogelsville, PA (US); Jiaming Zhang, Macungle, PA (US)

(72) Inventors: Peter W. Evans, Tracy, CA (US); Fred A. Kish, JR., Palo Alto, CA (US); Vikrant Lal, Sunnyvale, CA (US); Jacco Pleumeekers, Mountain View, CA (US); Timothy Butrie, Hellertown, PA (US); David G. Coult, Oley, PA (US); John W. Osenbach, Kutztown, PA (US); Jie Tang, Fogelsville, PA (US); Jiaming Zhang, Macungle, PA (US)

(73) Assignee: Infinera Corporation, Sunnyvale, CA (US)

(21) Appl. No.: 15/973,261

(22) Filed: May 7, 2018

(51) Int. Cl. G02B 6/43; H04J 14/06; H04B 10/61; G02B 6/42

(52) U.S. Cl. CPC G02B 6/43; H04J 14/06; H04B 10/541; G02B 6/4206; G02B 6/4213; H04B 10/6151

(57) ABSTRACT

Consistent with the present disclosure, one or more spare Widely Tunable Lasers (WTLs) are integrated on a PIC. In the event that a channel, including, for example, a laser, a modulator and a semiconductor optical amplifier in a transmitter or Tx PIC, or a laser, optical hybrid, and photodiodes, for example, in a receiver PIC (Rx PIC), includes one or more defective devices, a spare channel is selected that includes a widely tunable laser (WTL) which may be tuned to the wavelength associated with any of the channels on the PIC. Accordingly, the spare channel replaces the defective channel or the lowest performing channel and outputs modulated optical signals at the wavelength associated with the defective channel. Thus, even though a defective channel may be present, a die consistent with the present disclosure may still output or receive the desired channels because the spare channel replaces the defective channel. As a result, yields and minimum performance may improve compared to PICs that do not have a spare channel and manufacturing costs may be reduced. Alternatively, connections, such as fiber connections, may be made only to the operation or best performing channels.

### BACKGROUND

Photonic integrated circuits (PICs) may include multiple optical devices provided on a common substrate, including, for example, InP, gallium arsenide (GaAs), or other Group III-V materials. Such devices may include lasers, optical modulators, such as Mach-Zehnder modulators, semiconductor optical amplifiers (SOAs), variable optical attenuators (VOAs), optical hybrids, (de)multiplexers, and photodiodes. Lasers, modulators, SOAs, VOAs, and multiplexers are often provided in a transmitter PIC or TxPIC, and local oscillator lasers, VOAs, optical hybrids, demultiplexers, and photodiodes may be provided in a receiver PIC or RxPIC. Alternatively, both transmit and receive devices may be provided on the same substrate in a transceiver PIC (XCVR PIC.)

PICs that receive and/or transmit a large number of optical signals having different wavelengths typically have a relatively large number of devices integrated on a die. Accordingly, the probability that a die may be rendered unusable after processing is higher for high device-density die than low device density die because the high device-density die has more devices. High device-density die, therefore, often suffer from lower yield and increased cost. Furthermore, optical channels comprised of PIC channels, corresponding optics, ASICs, interconnections, and DSP chips may also have variable yield and performance. Accordingly, such devices may benefit from sparing.

### SUMMARY

Consistent with the present disclosure, one or more spare channels utilizing Widely Tunable Lasers or Widely Tunable Lasers (WTLs) are integrated on a PIC. In the event that a channel, including, for example, a laser, a modulator and a semiconductor optical amplifier in a transmitter or Tx PIC, or a laser, optical hybrid, and photodiodes, for example, in a receiver PIC (Rx PIC), includes one or more defective devices, a spare channel is selected that includes a widely tunable laser (WTL) which may be tuned to the wavelength associated with any of the channels on the PIC. Accordingly, the spare channel replaces the defective channel and outputs modulated optical signals at the wavelength associated with the defective channel. Thus, even though a defective channel may be present, a die consistent with the present disclosure may still output or receive the desired channels because the spare channel replaces the defective channel. As a result, yields and minimum performance may improve compared to PICs that do not have a spare channel and manufacturing costs may be reduced.

Preferably, the WTLs employed as part of a spare channel produce adequate optical power (for example, an optical power greater than or equal to 10 dBm). As used herein, WTLs are lasers that are tunable over the entire C, L, S, E or O-band (or at least 35 nm within their respective -bands). In addition, other components or devices may be used to facilitate the sparing in addition to the WTL, such as: other devices on the PIC, carriers upon which the PICs are mounted, application specific integrated circuits (ASICs) that supply/receive signals from the PIC, digital signal processors (DSPs) that connect to the ASICs, modules housing the PIC and/or ASIC, and connectors that connect the PIC to the ASIC and the ASIC to the DSP. Selection of channels to be used may be performed by electrical or optical connection (or lack of connection), and by logical or digital (e.g. Serial Peripheral Interface, SPI) selection.

Reference will now be made in detail to the present exemplary embodiments of the present disclosure, examples of which are illustrated in the accompanying drawings. In the following examples, coherent, polarization-multiplexed PICs and associated systems are described. It is understood, that optical systems and components, incorporating other optical modulation and transmission formats (e.g., on-off keying, OOK), may also incorporate spare channels consistent with the present disclosure.

### BRIEF DESCRIPTION OF THE DRAWINGS

FIGS. 1a-1c show examples of yield maps;

FIGS. 2a to 2h illustrate examples of transmitter PIC configurations consistent with aspects of the present disclosure;

FIGS. 3a to 3d illustrate examples of receiver PIC configurations consistent with additional aspects of the present disclosure;

FIG. 4 shows an example of a transceiver PIC configuration consistent with a further aspect of the present disclosure;

FIGS. 5a to 5h shows examples of fanout configurations consistent with aspects of the present disclosures;

FIGS. 6a and 6b illustrate examples of channel selection external to a PIC module consistent with an additional aspect of the present disclosure;

FIGS. 6c-6e illustrate examples of channel selection with external optics consistent with further aspects of the present disclosure;

FIGS. 7a and 7b illustrate examples of channel selection with an analog electrical switch consistent with aspects of the present disclosure; and

FIGS. 8a and 8b illustrates examples of channel selections based on Mach-Zehnder modulator driver controls consistent with additional aspects of the present disclosure.

### DETAILED DESCRIPTION

Photonic Integrated Circuits (PICs) enable an economy of scale when manufacturing, testing, and integrating them into optical systems. PICs also offer a platform to efficiently integrate a wide variety of opto-electronic devices (with low loss and low back-reflections), such as lasers, detectors, modulators, couplers, tuners, waveguides, amplifiers, optical hybrids, and waveguides onto a common substrate, such that the PIC may transmit and receive dense wavelength division multiplexed (DWDM) signals. However, as the channel count on the PIC and the number of devices per die increases, the probability increases that one or more channels have a defect or impaired performance compared to the others. Accordingly, yield or performance improvements are also limited so that cost increases or performance degrades with higher channel counts. Consistent with the present disclosure, however, one or more spare channels may be employed to address these problems. For example, a PIC may be designed to output N optical signals, each having a different wavelength, and N functional or primary channels may be provided on the PIC, each of which supplying a respective one of the N optical signals. k spare channels, in addition to the N channels, may also be provided, and a WTL in each spare channel can be tuned over a wide range so that the spare channel can replace or be a substitute for any one of the defective primary channels. Although spare channels increase the size of a chip or die, a larger number of good or better performing chips per wafer may be obtained, especially at higher channel counts.

In addition, two or more different types of chips (e.g. PIC and ASIC) are often provided, wherein an application specific integrated circuit (ASIC) supplies electrical signals to and/or receives electrical signals from the PIC. Accordingly, one or more spare electrical connections may be made to the PIC to further minimize overall cost.

An analysis of yield improvement consistent with the present disclosure will next be described. A PIC may require N primary channels, for example, and be designed to include k spare channels so that there are N+k channels physically located on the PIC, such that each channel includes at least one laser and one or more associated optical devices. The optimum number of spare channels may be determined for k=1 based on the random probability of a channel having a defect or failing is p:

PIC Yield=(N+1)×(1−p)×p^{N}+p^{N+1}=p^{N}×[1+N×(1−p)] (Eq. 1)

And for high yield for a given channel, p<<1 so that:

PIC Yield=p×N×(N+1) (Eq. 2)

In accordance with Eq. 2, therefore, PIC yield increases with (N+1). Accounting for the increased size of the PIC due to the extra k=1 spare channel, die size may be increased by a factor of N/(N+1) so that the number of good or usable PICs per wafer increases by N. Accordingly, yield may improve or increase with increasing channel count.

A similar analysis may be applied to more than one spare (i.e., k>1). In addition, impacts from random, clustered, and wafer-level defects may be considered. Such analysis can guide one to select an optimum number of spare channels to maximize good PICs per wafer.

Reference will now be made in detail to the present exemplary embodiments of the present disclosure, examples of which are illustrated in the accompanying drawings.

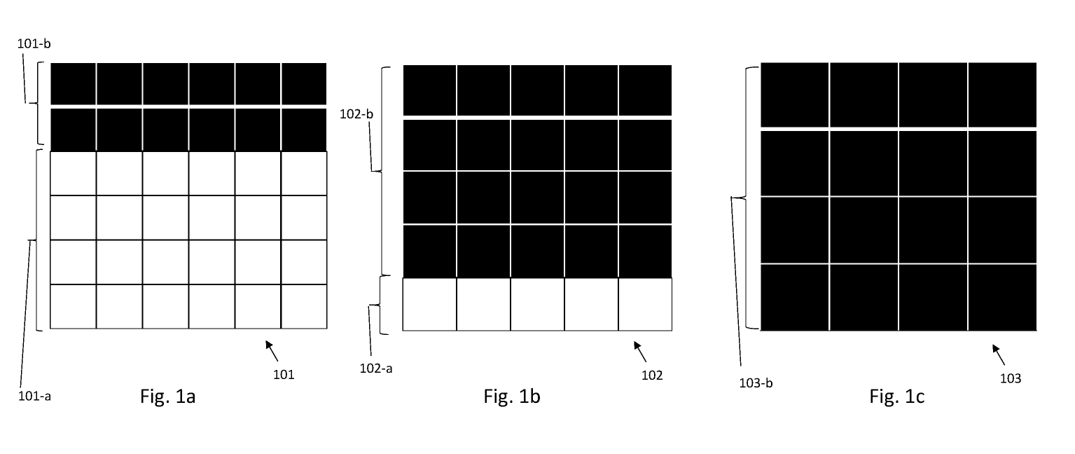

Improved yield based on sparing will next be described with reference to FIGS. 1a-1c, whereby smaller die sizes result in fewer passing chips (reduced yield) compared to larger die size chips having more passing chips (increased yield). In particular, FIG. 1a shows a yield map with dark squares 101-b representing passing chips and white squares 101-a corresponding to defective chips on a wafer 101. Here, each die is relatively small, and no spare channels are provided, such that relatively few die pass (low yield). In FIG. 1b, the die size is increased to accommodate spare channels in the die of wafer 102, and the number of passing die 102-b increases while the number of failing dice 102-a decreases. Since the die size increases in FIG. 1b relative to FIG. 1a, the number of die per wafer in FIG. 1b is less than in FIG. 1a.

The effect of sparing and die size is further shown in FIG. 1c. Here, each die of wafer 103 is made even larger to accommodate additional spare channels. Although each die from 103-b passes, the number of die per wafer decreases and the number of retrievable die from wafer 103 is less than that of wafer 102 in FIG. 1b (the size of wafers 101, 102, and 103 being the same in this example). Preferably, therefore, the number of spares is selected to provide an optimal yield based on die size, among other things. In the three examples shown in FIGS. 1a-1c, the die of wafer 102 shown in FIG. 1b have an optimal number of spares channels.

Overall module or system cost may also be considered when determining the best number of spare channels to use, since extra spare channels may increase the size, count or cost of other components. Use of spare channels may also be employed to improve performance of PICs that may not fail outright, but simply improve in performance by substitution of the spare channel(s) for lower performing channel(s) or result in selection of a PIC for higher performance requirements than otherwise possible or to avoid down-binning. Channel combining and splitting losses, if optical multiplexers/demultiplexer or combiners/decombiners are provided, may also be considered in determining the number of spares to provide, since in this case the additional spare channels may adversely affect performance and yield.

PICs having spare channels, consistent with the present disclosure, may be provided on Group III-V substrates, such as indium phosphide (InP) and gallium arsenide (GaAs). PICs consistent with the present disclosure may also be implemented with silicon photonics (SiP) in which certain devices of a channel may be integrated on a silicon substrate (including silicon, germanium, dielectrics and metals) and other devices may be provided on a second substrate including III-V materials (including InP, InGaAs, InGaAlAs, InGaAsP, GaAs, AlGaAs, glasses and metals). Further, the substrate may be monolithic or a hybrid integration of both silicon-based and III-V materials and devices.

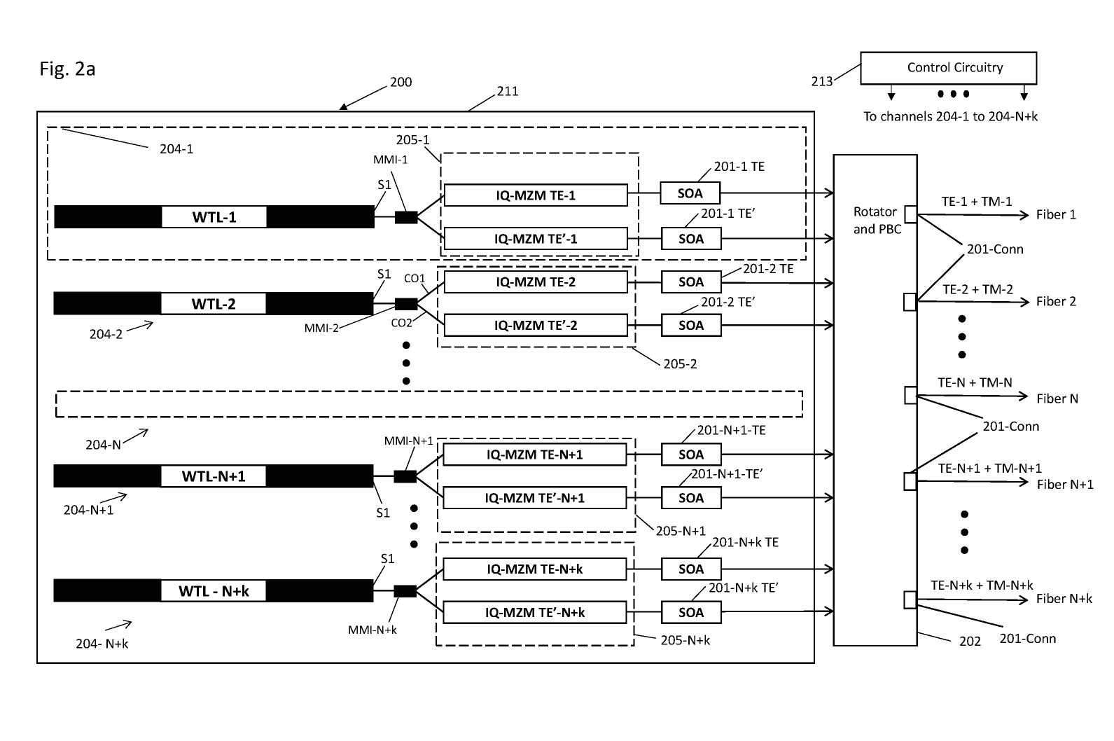

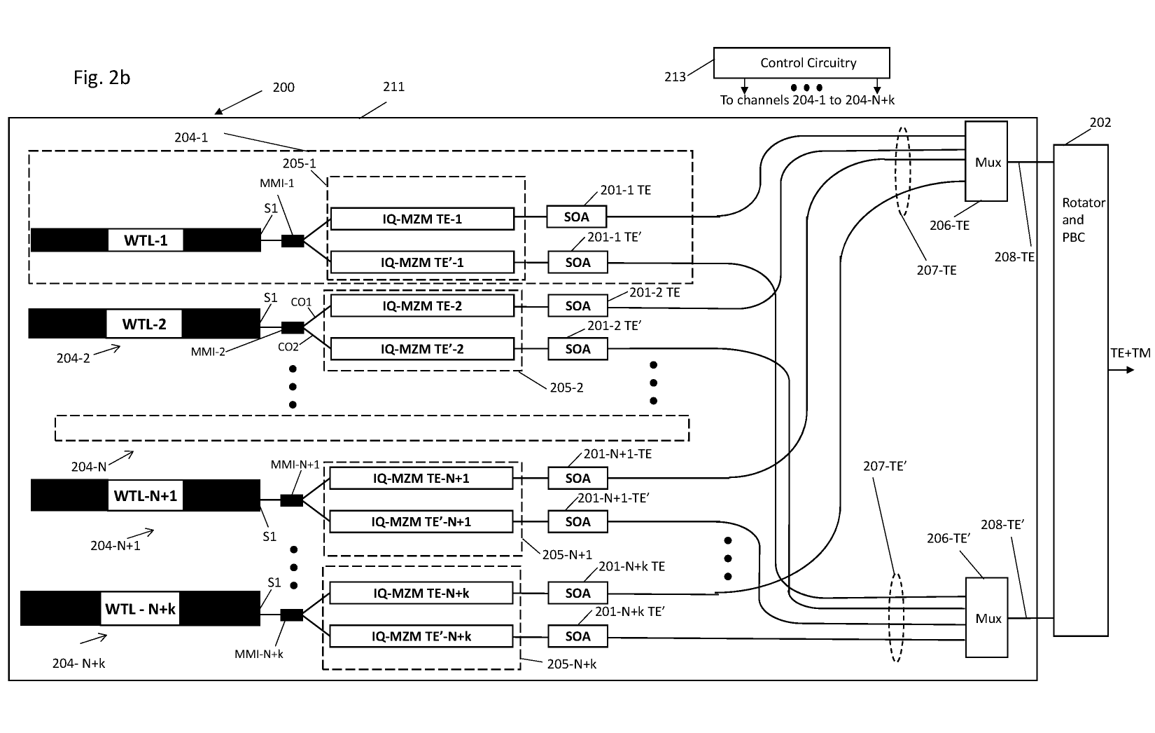

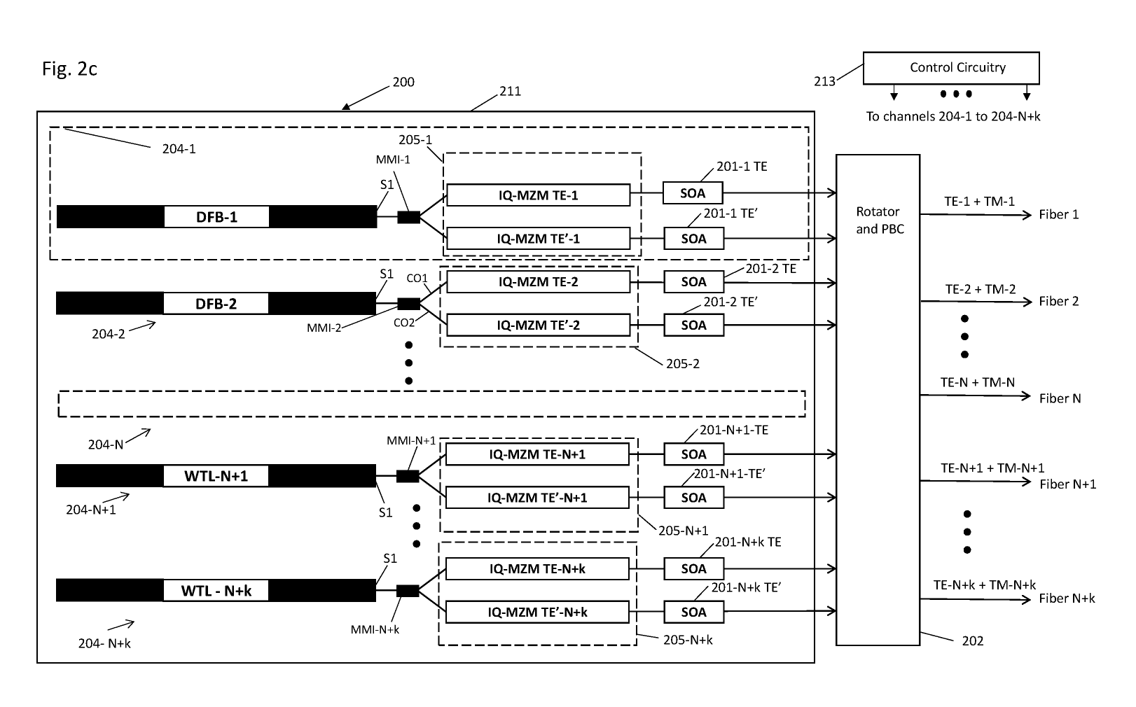

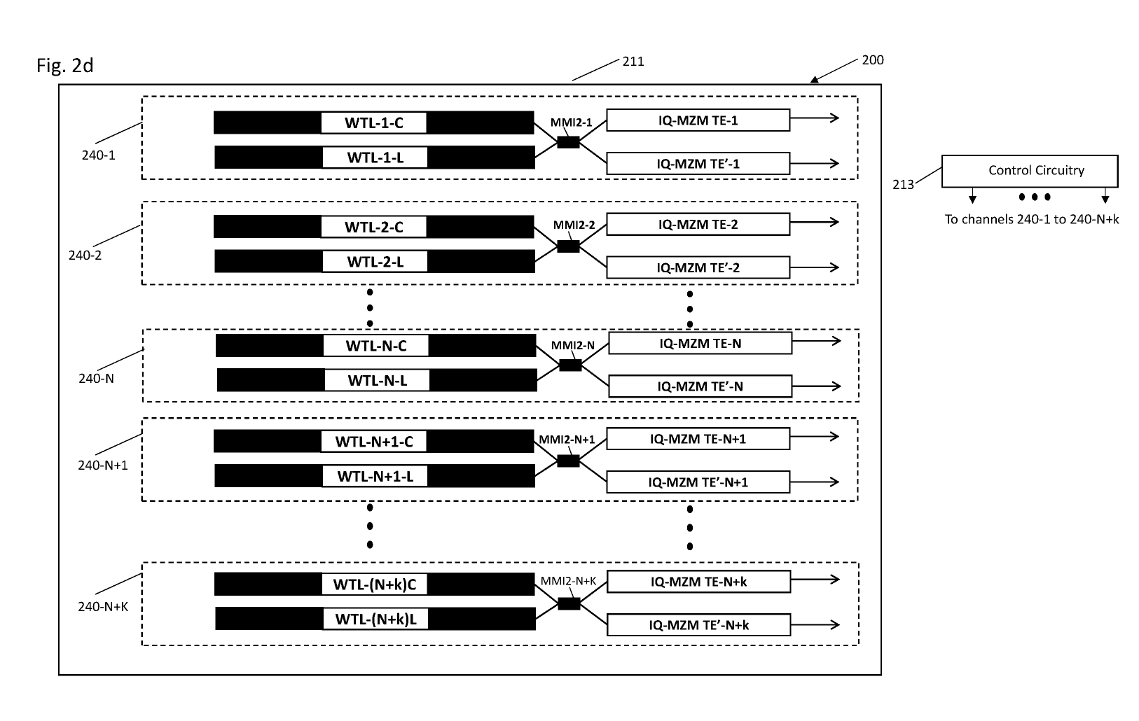

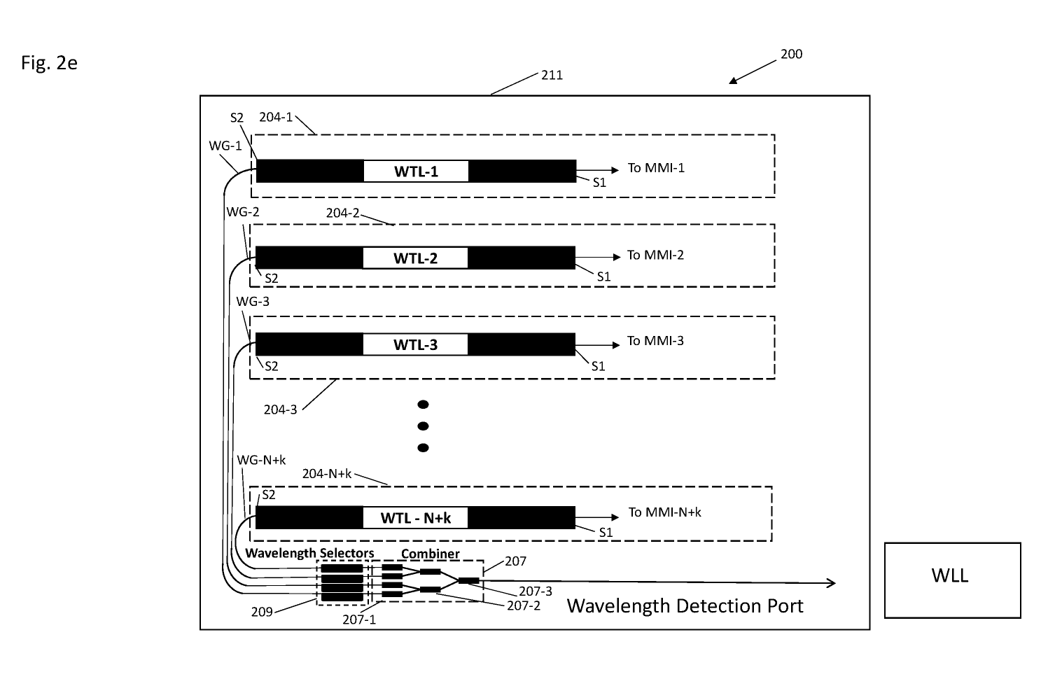

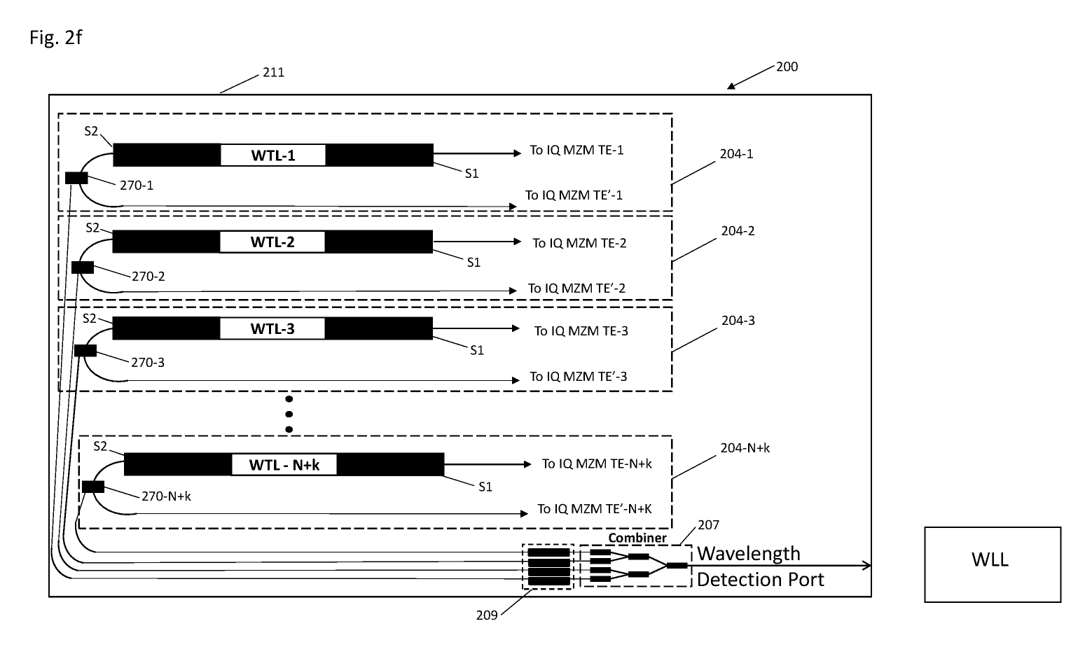

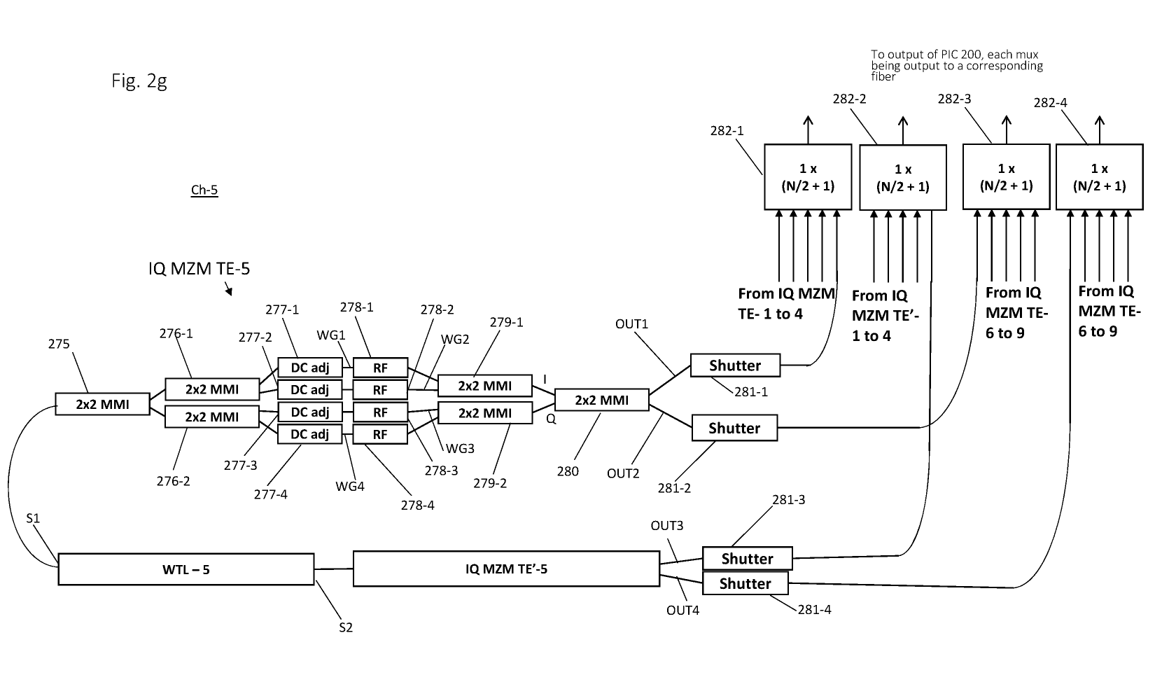

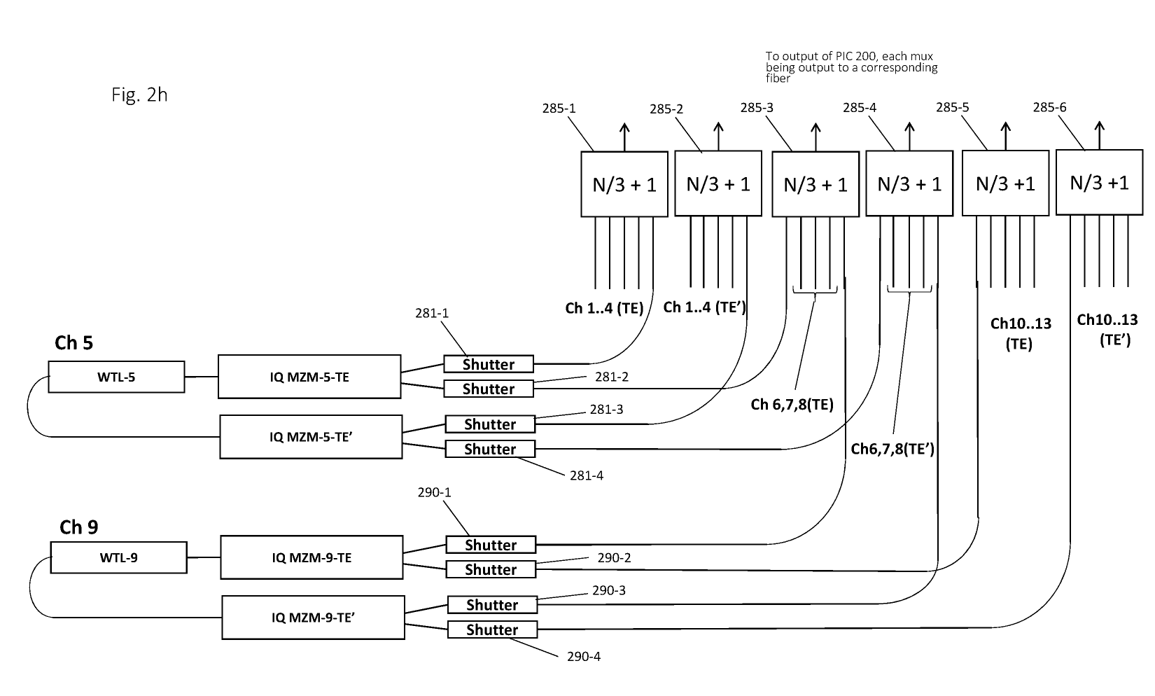

FIG. 2a shows an example of a transmitter (Tx) PIC 200 having spare channels 204-N+1 to 204-N+k (N and k both being integers) consistent with an aspect of the present disclosure. Tx PIC 200 is provided on substrate 211 and includes primary or working channels 204-1 to 204-N. Each of the spare channels 204-N+1 to 204-N+k includes a widely tunable laser (WTL), such as WTL-N+k. Each of the primary channels 204-1 to 204-N may include a laser, such as a WTL (for example, WTL-1 to WTL-N) or another type of laser, such as a distributed feedback (DFB) laser or a distributed Bragg reflector (DBR) laser, as discussed in greater detail below with reference to FIG. 2c. In certain applications, PICs in which both the primary and spare channels include WTLs may be easier to fabricate than PICs that includes WTL channels and primary channels that include other types of lasers, such as DFBs or DBR lasers.

As noted above and in each of the examples described herein, WTLs are lasers that are tunable over the entire C, L, S, E or O-band (or at least 35 nm within their respective-bands), such that the WTLs are tunable at least over a band of wavelengths defined by the wavelengths of optical signals supplied by the primary channels 204-1 to 204-N. Accordingly, channels including WTLs may spare any of the primary channels 204-1 to 204-N on PIC 200, such that the spare channels can supply optical signals having any wavelength within the band of wavelengths of optical signals output from the PIC, for example. Other lasers, such as DFBs, DBRs, and vertical cavity surface emitting lasers (VCSELs), are not suitable for use as spare channels because such lasers have a limited tuning range, and, at best, may only spare those channels having wavelengths that are the same as or substantially close to the optical signals supplied by the spare DFB, DBR, or VCSEL channel.

As further shown in FIG. 2a, each of primary channels 204-1 to 204-N and each spare channel 204-N+1 to 204-N+k, further includes at least one optical device, such as a respective pair of modulators 205-1 to 205-N+k and a respective one of couplers MMI-1 to MMI-N+k. Each modulator pair 205 may be a nested modulator and may include first and second IQ modulators, such that channel 204-1 includes IQ modulators IQ-MZM TE-1 and IQ MZM TE′-1, and channels 204-2 to 204-N+k include respective IQ modulators IQ-MZM TE-2 to IQ-MZM TE-N+k, as well as a respective IQ modulators IQ-MZM TE′-N+k. Each IQ modulator IQ-MZM TE-1 to IQ-MZM TE-N+k supplies an output or is coupled to a respective one of semiconductor optical amplifiers 201-1 TE to 201-N+k TE, and each IQ modulator IQ-MZM TE′-1 to IQ-MZM TE′-N+k supplies an output or is coupled to a respective one of SOAs 201-1 TE′ to 201-N+k TE′. In one example, each of the SOAs amplifies the received modulated optical signals in order to offset losses incurred by such signals during modulation, for example, or through splitting by the MIMI couplers, for example. In another example, control circuitry 213 may provide control signals to the SOAs 201 such that a pair of such SOAs is effectively turned off, grounded or reverse-biased, and thus is absorptive to the incoming optical signals. As such the selected SOAs 201 may also act to block or shutter light output from a particular channel to thereby deactivate such a channel.

In addition, SOAs 201 may selectively amplify or adjust the power of each received modulated optical signal so that each optical signal output therefrom has substantially the same power. Such “power flattening” is beneficial in systems carrying higher numbers of channels to compensate for designed and unintended source, routing, combining, and coupling variations across the intended band of wavelengths of the transmitted optical signals. Additionally, launch optical signal-to-noise ratio (LOSNR) for each optical signal is preferably preserved both by the signal integrity and a minimum optical power level for a given modulation format. By selecting an appropriate gain for each SOA 201, the desired launch power and LOSNR may be achieved. Such desired LOSNR may be beneficial in systems in which power combiners are used to multiplex the optical signals, as opposed to wavelength selective combiners, such as arrayed waveguide gratings (AWGs).

Returning to FIG. 2a, the outputs of each of the SOAs 201 may next be supplied to rotator and polarization beam combining circuits 202, which may be provided on substrate 211 or provided off-substrate 211. As further shown in FIG. 2a, rotator and polarization beam combiner (PBC) circuitry may be coupled to fibers 1 to N+k, each of which being configured to carry a pair of optical signals (TE-1, TM-1; TE-2, TM-2; . . . TE-N+k, TM-N+k). One signal (TE-1, TE-2, . . . TE-N+k) in each pair may have a transverse electric (TE) polarization and the other signal (TM-1, TM-2, . . . TM-N+k) in each pair may have a transverse magnetic (TM) polarization. As discussed in greater detail below, the selected N channels from N channels and k spare channels are typically activated so that not all outputs of the rotator and PBC circuitry will supply an output optical signal.

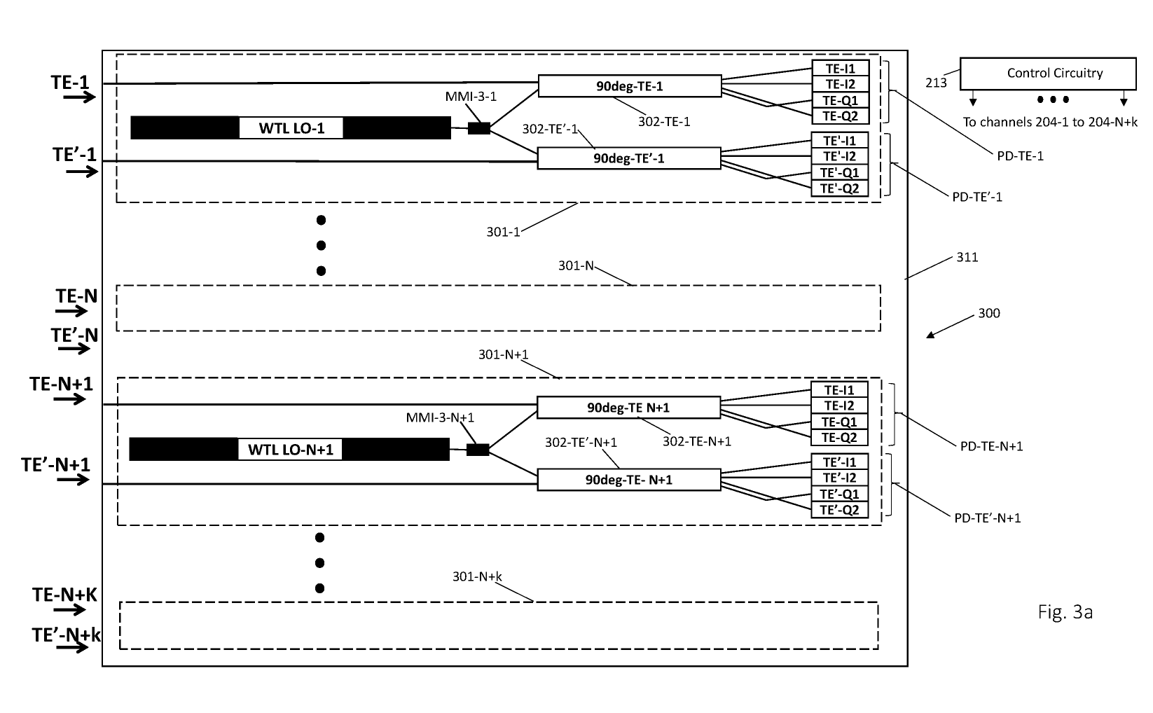

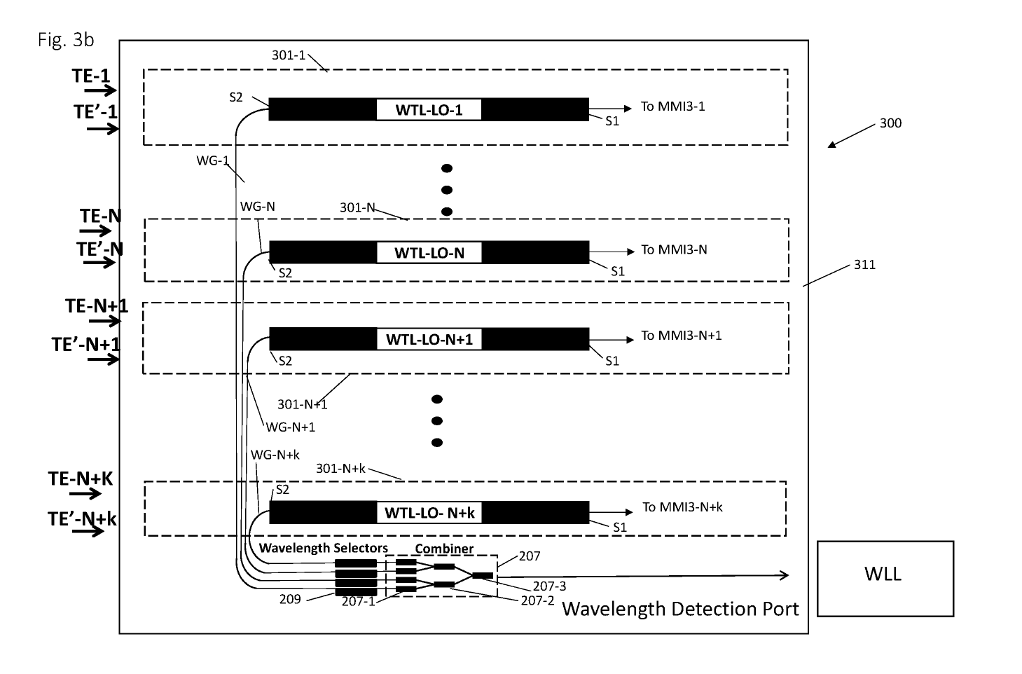

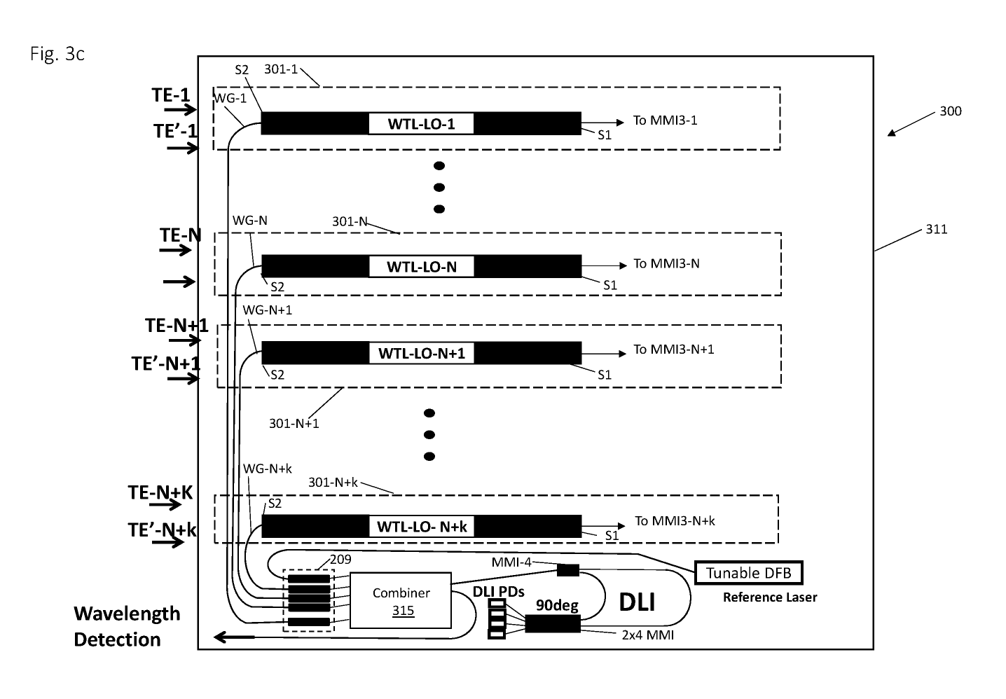

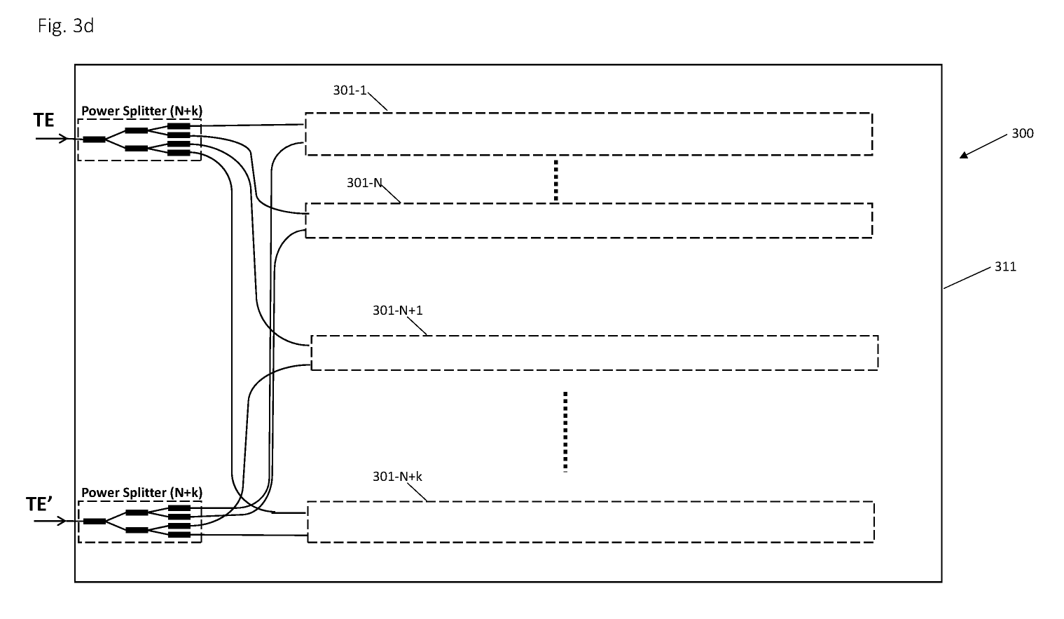

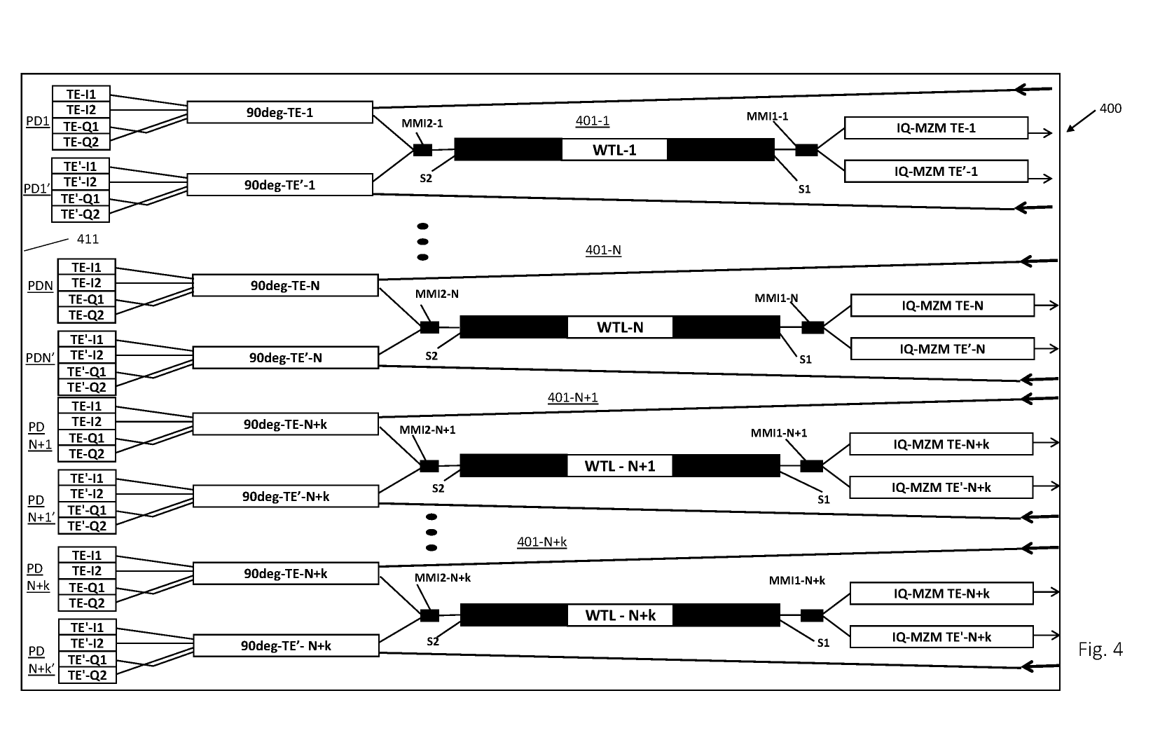

In another example, N optical connections, such as the optical connections between a respective one of channels 204-1 to 204-N+k and a corresponding one of Fibers 1 to N+k, are coupled to a respective one of a plurality of active optical channels. The plurality of active optical channels being those channels among channels 204-1 to 204-N+k (a set of optical channels) that transmit modulated optical signals (as in FIGS. 2a to 2h and the transceiver channels in FIG. 4) or receive modulated optical signal, such as channels 301-1 to 301-N+k in FIGS. 3a-3d and the transceiver channels 401-1 to 401-N+k in FIG. 4. A remaining channel or channels, such as channels 204-1 and 204-2, if found to be faulty, of the set of channels (204-1 to 204-N+k) are not coupled to any of the N optical connections. The remaining channel may be de-activated, such that the remaining channel does not supply or receive light that has been modulated to carry data. In that case, Fiber 1 and 2 may be omitted, and the other fibers, such as Fibers 3 to Fiber N+k may carry the modulated optical signals. Similar connections and configurations may be realized with the receiver implementations, wherein one of the receive channels 301 and transceiver channels 401 may be deactivated and the fiber that would otherwise be connected to such channel may be omitted. Such fiber connections may be made during assembly.

In another example, the optical connections may be realized with fiber connector, 201-Conn, such that N such fiber connectors may be provided to connect with a corresponding one of the N active channels in each of FIGS. 2a-2h, 3a-3d and 4 to corresponding fibers in these figures, but not to the deactivated channels in these examples.

In the example shown in FIG. 2a, and in other examples disclosed herein, each of the k spare channels may be the same as or similar to each of the N primary or working channels. It is understood, however, that the grouping or arrangement of primary and spare channel may be different than that shown in the drawings. For example, spare channels may be arranged in the center or closer to the edge of the PIC or a heat sink thermally coupled to the PIC. Moreover, the spare channels may have minor impairments, such as longer routing paths or different heat sinking depending on the location of the spare channels on the PIC. Moreover, any combination of N channels may be selected from the working and spare channels to provide optimal performance at the PIC level or at levels, such as analog coherent optical (ACO) or digital coherent optical (DCO) sub-assembly levels, for example. The PIC may be provided in a receiver sub-assembly, transmitter sub-assembly, or coherent optical module.

In operation, each of primary channels 204-1 to 204-N may be inspected and/or tested prior to deployment. If no defect is found, and each such channel operates at or above particular performance criteria, such as bit error rate and/or optical power level of a modulated optical signal output from a corresponding channel, none of the spare channels 204-N+1 to 204-N+k will be selected for activation. Accordingly, each of the primary channels 204-1 to 204-N are activated by outputs from control circuitry 213, such that each primary channel may output a corresponding one of N modulated optical signals.

On the other hand, if, prior to deployment, one or more devices in one or more of primary channels 204-1 to 204-N is found to include a defect or fault, or otherwise fails to meet the predetermined performance criteria noted above, the defective or underperforming primary channel(s) may be deactivated by outputs from control circuitry 213. Alternatively, a faulty channel may be one that has acceptable performance, e.g., supplies light with adequate power and sufficiently low noise, but such performance is less than that of other channels on the PIC. For example, based on such control signals, the voltage or current supplied to the laser(s) in the deactivated channel(s) may be reduced or cut-off. Alternatively, in accordance with a further example, DC bias signals or radio frequency (RF) signals going to the modulators 205, including IQ modulators, of the deactivated channel may be turned off, grounded, or replaced with blocking DC biases. Further, appropriate voltages and/or currents may be supplied to the lasers of the activated ones of spare channel(s) 204-N+1 to 204-N+k, and DC bias signals and/or RF signal may be provided to the modulators 205, including IQ modulators, of the activated spare channel. As a result, the activated spare channel(s) provide corresponding modulated optical signals that replace the modulated optical signals that would otherwise be output from the deactivated primary channel. Accordingly, N modulated optical signals continue to be output from PIC 200, as though each of the N primary channels was fully operational. Since the lasers provided in the spare channels are widely tunable, the modulated optical signal wavelengths may be tuned to match or substantially match the optical signal that would otherwise be output from the deactivated primary channels.

In another example, defective channels are identified as noted above, and optical fibers are coupled to those primary channels that are operational and the spare channels that replace the defective channels. Put another way, the PIC is fabricated to have N+k channels, but optical fibers are coupled to some number of channels less than N+k wherein the defective channels are not coupled to fibers. Preferably, in each of the examples described herein, identifying and sparing of defective channels is carried out prior to deployment. Alternatively, each of N+k fibers, in a ribbon cable, for example, may be coupled to a respective one of the N+k channels. After the defective channels are identified, however, optical connections or coupling is made to those fibers that transmit or receive optical signals from operational channels. Typically, N such optical connections are made if the PIC is designed to output N optical signals.

Further operation of Tx PIC 200 will next be described in connection with an example in which one of the primary channels, e.g., channel 204-1 is deactivated and one spare channel 204-N+1 is activated. It is understood, however, that additional spare channels may be activated in the event that one or more faults are identified in other primary channels 204-2 to 204-N prior to deployment.

Continuous wave light may be provided from output S1 of each of lasers WTL-2 to WTL-N+1. The light from each laser is supplied to an input of a corresponding one of couplers MMI-2 to MMI-N+1, which, in the example shown in FIG. 2a, includes a multimode interference (MMI) coupler. Each coupler MMI-1 to MMI-N+k has a first and second outputs, such as outputs CO1 and CO2 of The first output of each coupler of an activated channel feeds a first portion or a power split portion of the light supplied from a corresponding one of lasers WTL-2 to WTL-N+1 to a respective one of first IQ modulators IQ-MZM TE-2 to IQ-MZM TE-N+1, and the second output of each coupler feeds a second portion of the light supplied from a corresponding one of the lasers to a respective one of second IQ modulators IQ-MZM TE′-2 to IQ-MZM TE′-N+1. Each of the IQ modulators may include a Mach-Zehnder modulator, that outputs modulated in-phase (I) and quadrature (Q) components at each IQ modulator output. The I and Q components output from IQ modulators IQ-MZM TE-2 to IQ-MZM TE-N+1 are combined and each is supplied as one of N modulated optical signals to a respective one of SOAs 201-2 TE to 201-N+1 TE, and the I and Q components output from IQ modulators IQ-MZM TE′-2 to IQ-MZM TE′-N+1 are combined and each such combined components is supplied as one of N modulated optical signals to a respective one of SOAs 201-2 TE′ to 201-N+1 TE′. The SOAs, in turn, amplify the received modulated optical signals and supply the modulated optical signals to rotator and PBC circuitry 202. Using SOAs may be desirable in order to preserve launch optical signal to noise ratio (LOSNR) because coherent systems with higher order quadrature amplitude modulation (QAM) may have modulation loss of 10 dB or more, for example. SOAs may be provided in order to increase the optical power of the modulated optical signals and offset such loss. Each modulated optical signal has a TE polarization because light output from each laser 204 has the TE polarization. If modulated optical signals are combined with the same polarization, such signals would interfere with one another. Accordingly, the polarization of the optical outputs of SOAs 201-2 TE′ to 201-N+1 TE′, for example, may be rotated and polarization combined with outputs of SOAs 201-2 TE′ to 201-N+1 TE onto corresponding optical communication paths or fibers 2 to N+1 by rotator and PBC circuitry 202, in a manner similar to that described above. Alternatively, as discussed below with reference to FIG. 2c, each of the outputs of the mux 206-TE and 206-TE′ may be supplied to rotator and PBC circuitry external to the PICs and thus combined onto an optical fiber, for example.

Thus, light from spare channel 204-N+1 is output instead of deactivated channel 204-1 having a fault so that N polarization combined optical signals are output.

An exemplary integrated WTL typically has four sections: gain, phase, a first mirror section (having a first grating), and a second mirror section (having a second grating, for example). The first and second gratings may have different grating designs, such as, burst periods, or a chirped pitch, for example, that produce two different spectral combs of high reflection peaks rather than a single main reflection peak (in wavelength) that one would expect from a simple grating, for example. The two combs may be tuned together, by equally adjusting the temperatures of the gratings with adjacent heaters, for example, for continuous tuning over a relatively small frequency range. Alternatively, the two combs can be tuned differentially (by appropriate temperature adjustments) with respect to each other to select different reflection peaks across the C-band, leading to tuning in larger steps. As a result, tuning over a wide range, such as over the C-band can be achieved.

WTLs with high output power, for example greater than 10 mW and a narrow linewidth less than or equal to 500 kHz can be designed to provide light having wavelengths that can be tuned continuously over C-band (˜1528-1568 nm) or L-band (˜1565-1610 nm) wavelengths. Doped fiber amplifiers (based on silica or tellurite glasses) may provide high gain and low noise figure for optical signals having C-band and L-band wavelengths; however, these may not be readily integrated onto a monolithic PIC and hence increase cost, as well as require additional space and power consumption

FIG. 2b shows an example similar to that described above in connection with FIG. 2a. In FIG. 2b, each of the outputs of SOAs 201-2 TE to 201-N+1 TE (assuming that primary channel 204-1 has been deactivated and spare channel N+1 is activated, as described above) is fed first to a respective one of inputs 207-TE of multiplexer 206-TE before rotator and PBC circuitry 202. Multiplexer 206-TE may combine the received SOA outputs onto an output, including, for example, an optical communication path, such as an optical fiber 208-TE. Similarly, each of the outputs of SOAs 201-2 TE′ to 201-N+1 TE′ may be supplied to a corresponding one of inputs 207-TE′ of multiplexer 206-TE′. Multiplexer 206-TE′ may likewise combine the received SOA outputs onto an output, including, for example, an optical communication path, such as an optical fiber 208-TE′. The combined optical signals on output 208-TE′ may be supplied to a rotator component, which rotates the TE polarization of such TE′ signals to be the TM polarization. A polarization beam combiner (PBC) component may also be provided to combine such TM polarized optical signals and the TE polarized optical signals carried by output 208-TE onto a PBC output (TE+TM). The operation of the example shown in FIG. 2b is otherwise similar to or the same as that discussed above in connection with FIG. 2a.

In the example shown in FIG. 2b, multiplexers 206-TE and 206-TE′ may each include an arrayed waveguide grating (AWG), Eschelle grating, MMI coupler or other suitable optical combiner or multiplexer that is suitable for the wavelength, power, crosstalk, LOSNR and other optical system performance requirements.

FIG. 2c shows another example which is also similar to that described above with reference to FIG. 2a. In FIG. 2c, however, each widely tunable laser in primary channels 204-1 to 204-N is substituted by respective one of distributed feedback (DFB) lasers, DFB-1 and DFB-N. The DFB may be a fixed wavelength, or narrowly tunable (e.g., =<10 nm or a ¼ of the C or L-Band). This may be accomplished for example by thermal tuning (placing a heater next to the DFB). Alternatively, the DBR (distributed Bragg reflector) lasers could be substituted for the DFBs. DBRs are also typically tunable over a limited tuning range (e.g., =<10 nm). Each of the spare channels 204-N+1 to 204-N+k has a WTL laser, as in the above examples. The WTL spare channels are tunable across the deployment spectrum of the DFB or DBR channels. Thus, the wide tuning of the WTL enables sparing for any of the laser channels. The operation of the example shown in FIG. 2c is otherwise similar to or the same as that discussed above in connection with FIG. 2a. Similar to FIG. 2b, a multiplexer, AWG or Eschelle grating with adequately large free spectral range (FSR) may be used to combine TE or TE′ signals before rotation and combining.

Alternatively, all of the channels in FIG. 2C may be configured with WTLs. This would provide the most flexibility in the channel plan for the deployments of the devices. WTLs may occupy more space on the PIC substrate than DFBs and have more integrated elements and are therefore more likely to have a defect. WTLs, therefore, may also have a lower yield than DFBs. Accordingly, the example shown in FIG. 2c, in which each of the primary lasers 204-1 to 204-N is a DFB, may have improved size, yield or cost compared to that shown in FIG. 2a, for example, in which each of the primary lasers 204-1 to 204-N is a WTL and may be preferred for applications with wavelength-dependent combiners.

FIG. 2d shows an example in which PIC 200 outputs modulated optical signals over both the C and L-bands. In FIG. 2d, features, such as control circuitry 213, and SOAs 201 are not shown for ease of illustration. As shown in FIG. 2d, PIC 200 includes a substrate 211 and N primary channels 240-1 to 240-N provided thereon. Each of the N primary channels 240-1 to 240-N has a corresponding one of first WTLs tunable over the C-band and a corresponding one of second WTLs tunable over the L-band.

PIC 200 further includes a plurality of k spare channels (240-N+1 to 240-N+k.) Each of the plurality of spare channels includes a corresponding one of third WTLs tunable over the C-band and a corresponding one of fourth WTLs tunable over the L-band. In addition, each of primary channels 240-1 to 240-N includes a corresponding one of MMI couplers MMI2-1 to MMI2-N, and each of the spare channels 240-N+1 to 240-N+k includes a corresponding one of MMI couplers MMI2-N+1 to MMI2-N+k.

Each MMI2 has a first and second inputs that are respectively coupled to the C-band WTL and the L-band WTL in each channel. Each MMI2 also has a first output which is coupled to a respective one of optical devices, such as IQ modulators IQ-MZM TE-1 to IQ-MZM TE-N+k, and a second output that is coupled to a corresponding one of IQ-MZM TE-1 to IQ-MZM TE-N+k.

In operation, if all primary channels 240-1 to 240-N are operational, one of the C-band and L-band WTLs in each channel is activated. Light output from each such activated laser is supplied to a corresponding one of MMI couplers (MMI2-1 to MMI2-N) and first and second power split portions of the light is supplied to respective IQ modulators IQ-MZM TE and IQ-MZM TE′. Each IQ modulator supplies combined in-phase and quadrature components, which are then subject to further processing, e.g., multiplexing, and selective polarization rotation, as discussed above.

If one or more of primary channels 240-1 to 240-N is determined to include a fault or defect, such as in the one of the C-band or L-band WTLs or in one of the IQ modulators or the MMIs, control circuitry 213 supplies controls signals, similar to those discussed above to deactivate the faulty channel. Control circuitry also supplies control signals to activate a corresponding number of WTLs in the band(s) corresponding to those (or that) of the defective channels. Accordingly, if, for example, WTL-1-C of primary channel 240-1 were found to be defective, channel 240-1 would be deactivated by control circuitry 213. In addition, control circuitry 213 activates a corresponding C-band WTL in one of the spare channels, such as WTL-N+1-C, so that the activated spare channel replaces any one of the primary channels, which in this case is primary channel 240-1. The L-band WTL in the activated spare channel is also deactivated. That is, consistent with the present disclosure, the unused WTLs in the activated spare are deactivated along. Channels and both WTLs in each spare are described above.

FIG. 2e shows another example which is similar to that shown in FIG. 2a but further illustrates circuitry for wavelength monitoring and control. For ease of illustration, only the WTLs and wavelength detector circuit for each of primary channels 204-1 to 204-N and spare channels 204-N+1 to 204-N+k are shown in FIG. 2e.

As noted above with respect to the example shown in FIG. 2a, light from one of side or output of each laser is power split by a respective MIMI coupler. In FIG. 2e, however, light from the second side or output, opposite the first side or output, of each WTL is supplied via respective one of waveguides WG-1 to WG-N+k to a corresponding one of wavelength selectors 209, each of which may include an optically attenuating device, such as a variable optical attenuator, SOA, or Mach-Zehnder interferometer to selectively pass or transmit light output from the lasers on waveguides WG-1 to WG-N+k. Preferably, one light output at a time is provided to a corresponding input of combiner 207, including coupler or MMI stages 207-1, 207-2, and 207-3, and passed through these stages to an output. The output is coupled to a wavelength detection port, which, in turn, supplies the light to a control circuit or wavelength detection and/or locking circuit WLL.

Instead, wavelength selectors 209 may instead supply different-frequency tones to the light input on the wavelength selectors corresponding to waveguides WG-1 to WG-N+k so that the wavelength detection circuit (WLL) may process and lock all wavelengths in parallel. Preferably wavelength selector modulation (whether amplifying, shuttering, or toning) is performed at a rate faster than the thermal time constant of various elements on the PIC 200 so that thermal effects are minimized. Accordingly, each wavelength selector 209 should be modulated at least at a frequency of 1 kHz, preferably at least 2 kHz, and most preferably at a frequency greater than or equal to 10 kHz.

FIG. 2f shows an alternative example in which light output from the second side or second output S2 of each WTL (i.e., each WTL in the primary channels 204-1 to 204-N and each WTL in the spare channels 204-N+1 to 204-N+k) may be provided to an input to respective one of a plurality of taps 270-1 to 270-N+k. Each tap has a first output that supplies a power split portion of the received light from a respective WTL to a corresponding one of the plurality of selectors and a second output that is coupled to a corresponding one of IQ modulators IQ MZM TE′-1 to IQ MZM TE′-N+k. Each of IQ modulators IQ MZM TE-1 to IQ MZM TE-N+k may receive light from a first side or first output Si of a corresponding one of lasers WTL-1 to WTL-N+k in a manner similar to that described above. Wavelength monitoring and control is carried out in a manner similar to that described above with reference to FIG. 2e, except that the light supplied to the selectors is a power split portion of the light supplied by or output by a corresponding second side S2 of each WTL lasers.

The example shown in FIG. 2f may avoid waveguide crossings that may introduce loss, cross-talk, and reflections, and therefore is typically preferred over other methods that require waveguide crossings. Other components may also be integrated in this scheme (not shown) including a reference DFB laser similar to another channel input to another wavelength selector. Also, a delay line interferometer may be integrated on the PIC using a second output from the combiner 207, as discussed in greater detail below. Also, an SOA or a polarizer may be provided at the wavelength detection port to amplify and improve the preferred polarization (usually TE) or degrade the power of the non-preferred polarization (usually TM) for best wavelength determination by the WLL.

FIG. 2g shows an example in which the light supplied from the second output or second side of a WTL may be modulated and used as a spare channel output. FIG. 2g also shows an example of an IQ modulator associated with channel 5 (CH5) of N=9 channels. The remaining channels may have the same or similar structure as that shown in FIG. 2g.

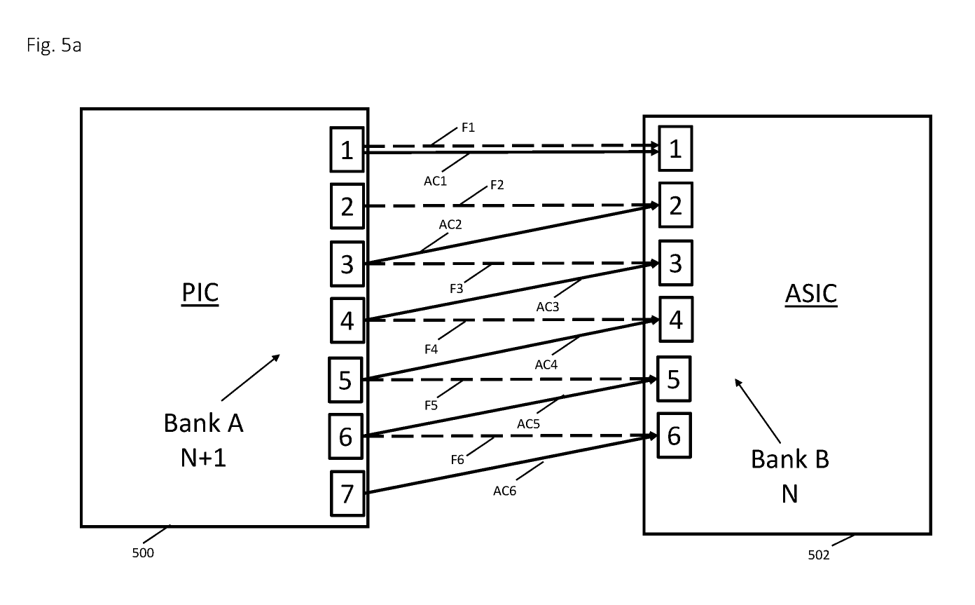

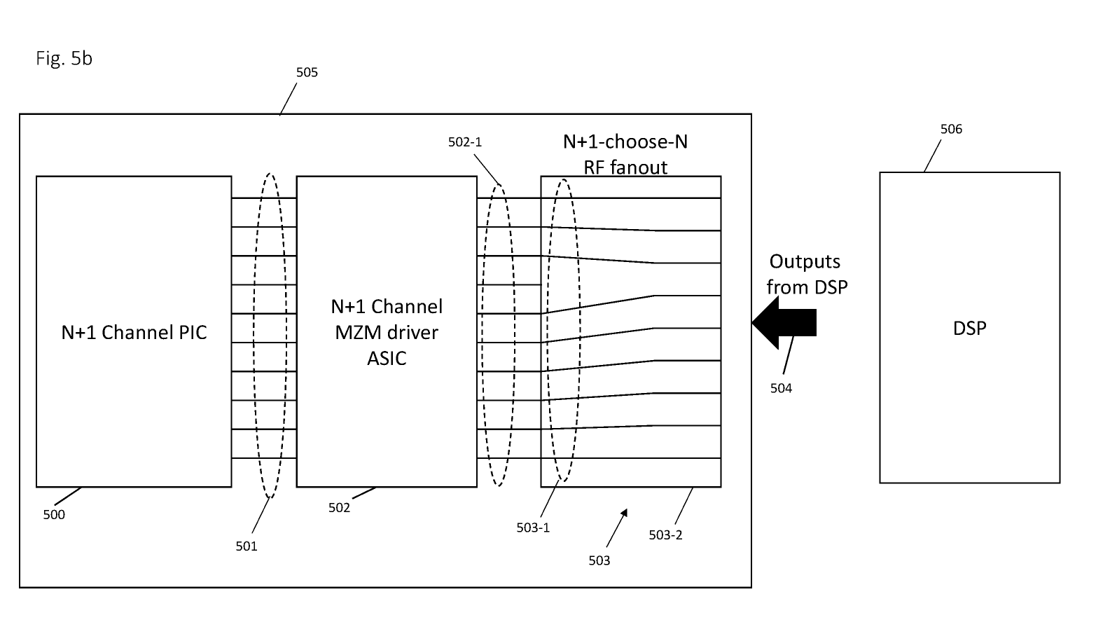

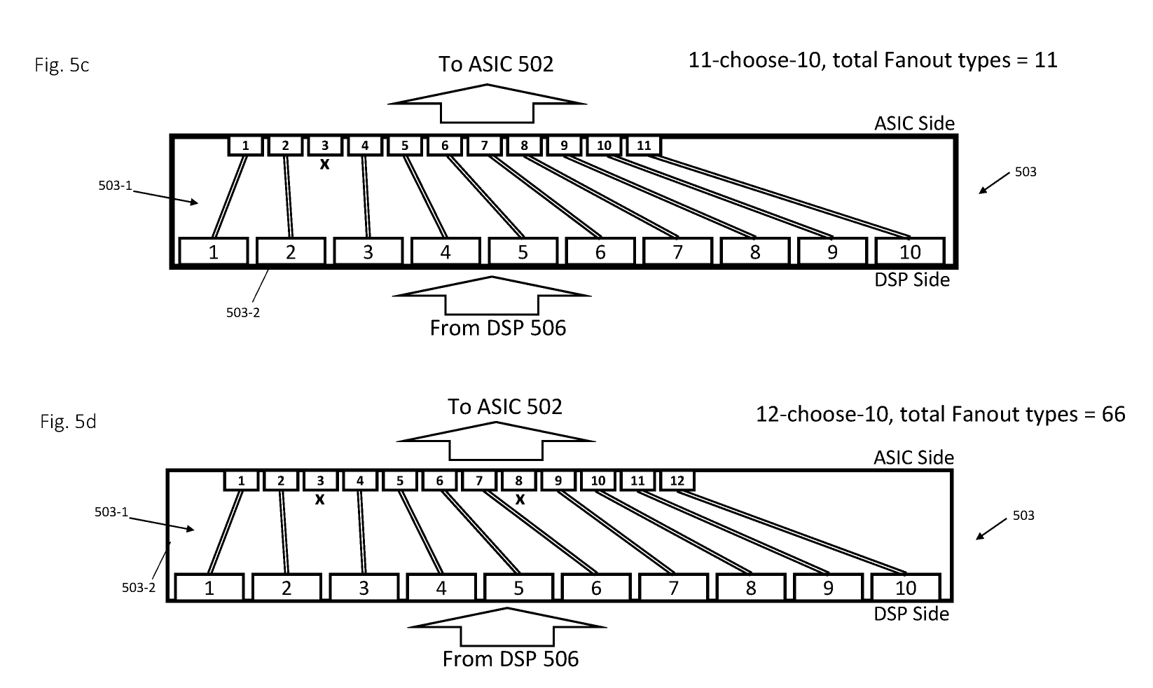

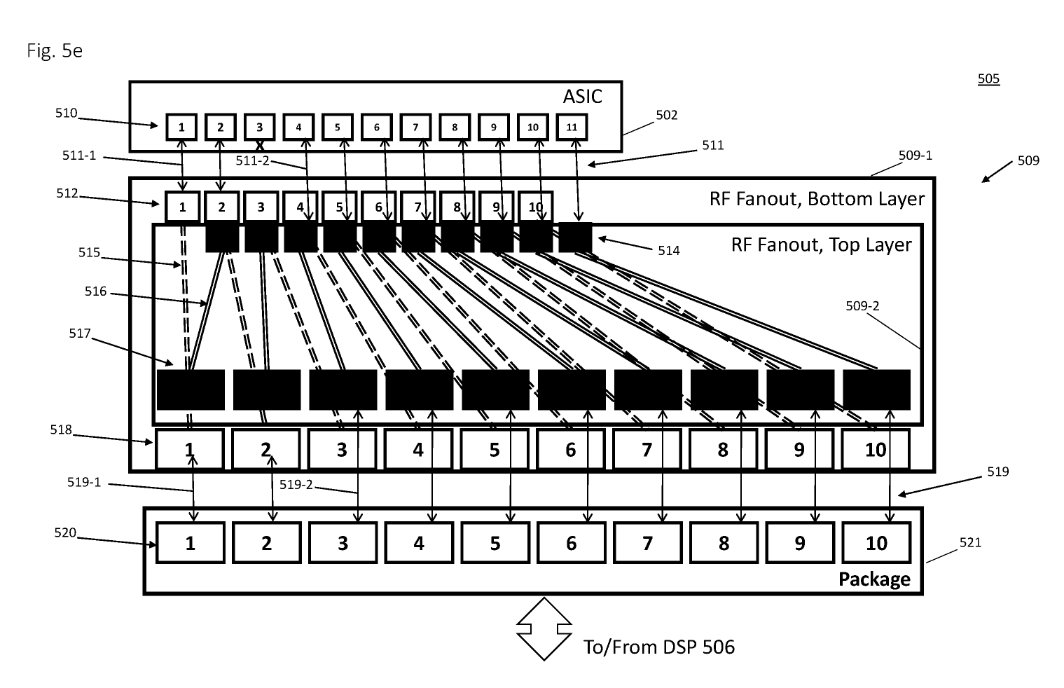

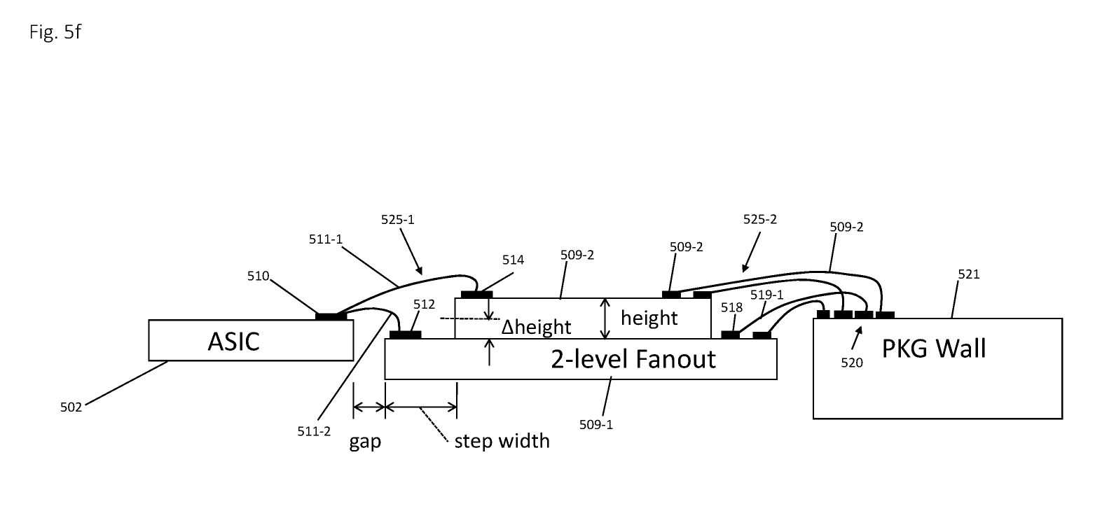

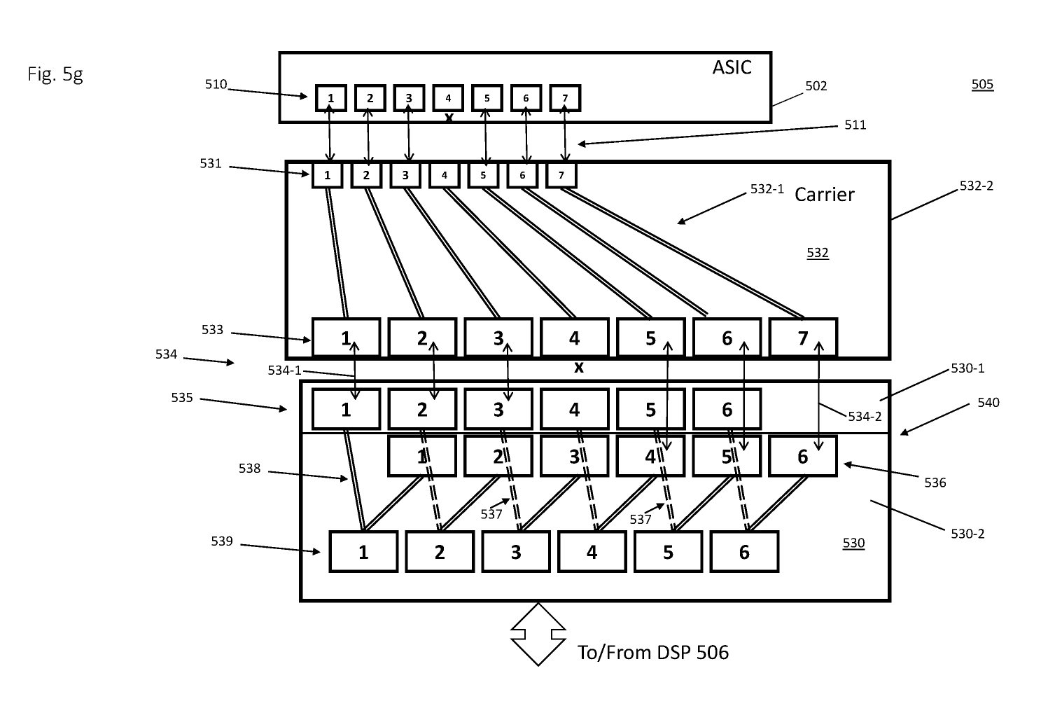

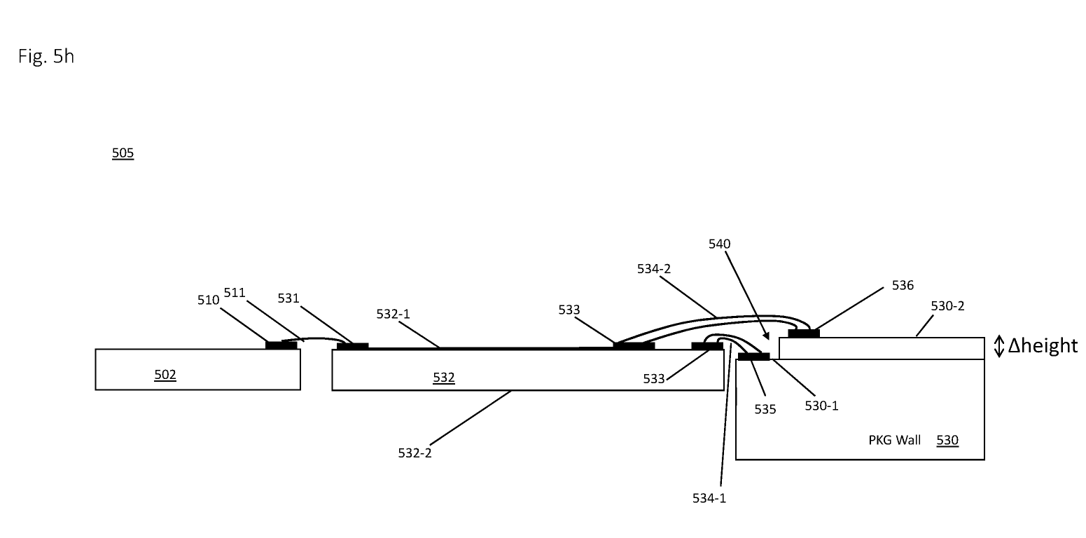

CH5 includes a laser, WTL-5 having first and second outputs or sides, S1 and S2. Continuous wave (CW) light output from output S1 is supplied to an input of splitter 275, which may include a 2-input×2-output (2×2) MMI coupler. Splitter 275 may provide a first output including a first portion of the light to splitter 276-1 and a second output including a second portion of the light to splitter 276-2, both of which may include 2×2 MMI couplers. Splitter 276-1 has first and second outputs, the first output is a first waveguide WG1 that extends beneath or adjacent to a first electrode (277-1) and the second output is a second waveguide WG2 that extends beneath or adjacent to a second electrode 277-2. Alternatively, 275, 276-1 and 276-2 could be a single 1×4 splitter. Splitter 276-2 also has first and second outputs, the first output of splitter 276-2 is a third waveguide WG3 that extends beneath or adjacent to a third electrode (277-3) and the second output of splitter 276-2 is a fourth waveguide WG4 that extends beneath or adjacent to a second electrode 277-4. Electrodes 277-1 and 277-2 may receive a direct current (DC) or slowly varying bias to properly adjust a biasing point of a first Mach-Zehnder modulator that constitutes splitter 276-1, the first and second waveguides WG1 and WG2 and combiner 279-1. In addition, electrodes 277-3 and 277-4 may receive a DC or slowly varying bias to properly adjust a biasing point of a second Mach-Zehnder modulator that constitutes splitter 276-2, the third and fourth waveguides WG3 and WG4 and combiner 279-2. As further shown in FIG. 5, high frequency (RF), data carrying drive signals may be supplied to RF electrodes 278-1 and 278-2 of the first push-pull Mach-Zehnder modulator, and additional RF signals may be supplied to RF electrodes 278-3 and 278-4 of the second Mach-Zehnder modulator. As a result, the first Mach-Zehnder modulator comprised of 278-1 and 278-2 may supply an in-phase (I) component of the TE optical signal output from Ch5 and the second Mach-Zehnder modulator may supply a quadrature (Q) component of the optical signal output from Ch5.

The I and Q components from 2×2 MMI couplers 279-1 and 279-2 may then be combined in 2×2 MMI coupler 280 which has two output ports OUT1 and OUT2, which respectively supply power split from first and second portions of the combined I and Q components, which constitute the CH5 TE modulated optical signal. OUT1 supplies the first portion of the CH5 TE optical signal to a first shutter 281-1 and OUT2 supplies the second portion of the CH5 TE optical signal to a second shutter 281-2. The first and second shutters 281-1 and 282-2 may be an optical amplitude adjusting device including, for example, one or more of an SOA, VOA, and a Mach-Zehnder interferometer. Shutter 281-1 is coupled to an input of multiplexer 282-1, which also has inputs that receive respective outputs from IQ modulators IQ MZM TE 1-4, and shutter 281-3 is coupled to an input of multiplexer 282-2, which also has inputs that receive respective outputs from IQ modulators IQ MZM TE′ 1-4.

As further shown in FIG. 2g, CW light supplied from the second side or output of WTL-5 may be provided to IQ modulator IQ MZM TE′-5, which has the same or similar to structure and operation at IQ MZM TE-5, to supply power split portions (IQ components) of a CH5′ TE optical signal to third shutter 281-3 and fourth shutter 281-4, each of which may also be an optical amplitude adjusting devices. Shutter 281-3 is coupled to an input of multiplexer 282-2, which also has inputs that receive respective outputs from IQ modulators IQ MZM TE′ 6-9, and shutter 281-4 is coupled to an input of multiplexer 282-4, which also has inputs that receive respective outputs from IQ modulators IQ MZM TE′ 6-9.

Channels 1 to 4 and 6 to 9 may have the same or similar structure as CH5. In the event that one of channels 1 to 4, such as channel 1, is defective, shutters 281-1 and 281-3 may be biased by control circuitry 213 (not shown in FIG. 2g) to transmit CH5 TE and TE′ modulated optical signals to corresponding inputs of multiplexers 282-1 and 282-2, while corresponding shutters in channel 1, as well as shutters 281-2 and 281-4, are biased to be in a blocking state. Likewise, if one of channels 6 to 9 is found to be defective, the shutters of the defective channel may be rendered blocking and shutters 281-1 and 281-3 rendered blocking while shutters 281-2 and 281-4 may be biased to supply light to inputs of multiplexers 282-3 and 282-4.

In FIG. 2g, sparing is achieved by extending each polarization optical path (TE and TE′) from both outputs of the TE and TE′ IQ modulators through a shutter to the facet or PIC output. By shuttering the complementary output of each IQ modulator, one of two possible groups of N/2 outputs is provided with a spare (k=1) channel. Accordingly, each multiplexer in the example shown in FIG. 2g has N/2+1 inputs.

FIG. 2h shows an example in which a limited number of spare channels, such as channels 5 (CH5) and 9 (Ch9) may be used to spare groups of primary channel outputs that are multiplexed and output on a corresponding one of a plurality of optical fibers. Such fibers may route the optical signals in different directions in an optical communication system, wherein each fiber carries a subset or fraction of the total number of channel outputs. In this case, although both CH5 and Ch9 maybe be used in different channel groups for coupling to different fibers, at least one of CH5 and Ch9 must be used to attain 4 channels per fiber so that the other channel may serve as a spare channel.

The structure and operation of spare CH5, as well as shutters 281-1 to 281-4 are described above in connection with FIG. 2g. Spare Channel 9 (Ch9) also includes IQ modulators, namely, IQ MZM-9-TE and IQ MZM-9-TE. In addition, each output of Ch9 is fed to a corresponding one of shutters 290-1 to 290-4, which may include the same or similar devices as shutter 281-1 to 281-4 described above, for example.

As further shown in FIG. 2h, shutter 281-1 selectively supplies CH5 TE signals to an input of multiplexer 285-1, and shutter 281-3 selectively supplies CH5 TE′ signals to an input of multiplexer 285-2. Also, each of remaining inputs of multiplexer 285-1 are coupled to a corresponding TE output of channels 1 to 4, and each of remaining inputs of multiplexer 285-2 is coupled to a TE′ output of a corresponding one of channels 1 to 4.

Shutters 281-2 and 290-1 selectively supply Ch TE-5 and Ch TE-9 optical signals from channels CH5 and Ch9, respectively, to corresponding inputs of multiplexer 285-3. Each of remaining inputs of multiplexer 285-3 is coupled to a respective TE output of channels 6 to 8. In addition, shutters 281-4 and 290-3 selectively supply Ch TE′-5 and Ch TE′-9 modulated optical signals from IQ modulators in channels CH5 and Ch9, respectively, to corresponding inputs of multiplexer 285-4. Each of remaining inputs of multiplexer 285-4 is coupled to a respective TE′ output of channels 6 to 8. Further, shutters 290-2 and 290-4 selectively supply TE and TE′ modulated optical signals to inputs of multiplexers 285-5 and 285-6, respectively. Each of remaining inputs of multiplexer 285-5 is coupled to a corresponding TE output of channels 10 to 13, and each of remaining inputs of multiplexer 285-6 is coupled to a corresponding TE′ output of channels 10 to 13.

In the example shown in FIG. 2h, a spare channel is provided on a PIC, such as PIC 200, having 12 channels and three pairs of outputs. If the number of output pairs is M, at most M−1 channels are preferably switchable to a spare. The number is reduced as more spare channels are targeted to be used. Further, each of multiplexers 285-1 to 285-6 has (N/M)+1 inputs. Here, the primary channels are arranged in groupings of N/3, which are smaller than the N/2 primary groupings in FIG. 2g. One or more sparing channels, such as CH5 and Ch9 (for the case of M−1=2) may be provide for each grouping.

FIG. 3a illustrates an example of an Rx PIC 300 consistent with an aspect of the present disclosure. Rx PIC 300 may be provided on substrate 311 and includes primary channels 301-1 to 301-N, as well as spare channels 301-N+1 to 301-N+k. For ease of explanation, details of primary channel 301-1 and spare channel 301-N+1 will next be described. Remaining primary and spare channels shown in FIG. 3a have the same or similar structure and operation as channels 301-1 and 301-N+1.

Each channel includes a respective one of widely tunable local oscillator (LO), such as WTL LO-1 and WTL LO-N+1. The output of each WTL LO is supplied to an MMI coupler, for example, such as MMI couplers MMI-3-1 and MMI-3-N+1. Each MMI has a first output and a second output, the first output is coupled to a first 90 degree optical hybrid circuit 90 deg-TE-1 and the second output is coupled to a second hybrid circuit 90 deg-TE′-1. As further shown in FIG. 3a, spare channel 301-N+1 may also have an MMI coupler (MMI-3-N+1) having an input coupled to WTL LO-N+1 and first and second outputs respectively coupled to hybrid circuits 90 deg-TE-N+1 and 90 deg-TE′-N+1.

Optical hybrid 90 deg-TE-1 also receives a first incoming TE polarized modulated optical signal from a polarization beam splitter and (not shown) and optical hybrid 90 deg-TE′-1 may receive a second incoming TE polarized modulated optical signals from the polarization beam splitter after being polarization rotated by a polarization rotator (not shown). Each optical hybrid mixes a respective one of the incoming optical signals (TE-1 and TE′1, for example) with LO light supplied from a respective MMI output. The resulting mixing products output from each optical hybrid circuit are supplied to a respective one of photodiode groupings PD-TE-1 and PD-TE′-1. The “I” and “Q” designations shown in FIG. 3a represent the TE/TE′ in-phase and TE/TE′ quadrature components, respectively, detected by each photodiode. The electrical outputs of the photodiodes are subject to further processing to recover data carried by the modulated optical signals (not shown.) Remaining primary channels 301-2 to 301-N operate in a similar fashion to detect optical signals TE-2 to TE-N and TE′2 to TE-N supplied from the polarization beam splitter.

In the event a fault is identified in one of primary channels 301-1 to 301-N, prior to deployment, for example, control circuitry 213 may deactivate the faulty channel in a manner similar to that described above. In addition, control circuitry 213 may activate one of the spare channels, such as spare channel 301-N+1. As noted above, spare channel 301-N+1 as well as the other spare channels have a structure similar or the same as that of each of the primary channels 301-1 to 301-N. Accordingly, when activated, the spare channel may mix, in the 90 degree optical hybrids, LO light with the incoming TE and TE′ optical signals associated with the defective channel. Here, such optical signals are shown as TE-N+1 and TE′-N+1. Preferably, the spare WTL LO, such as WTL LO-N+1, is tuned to output a wavelength corresponding to the wavelength of the deactivated channel to ensure that the LO light beats with the incoming optical signals for proper detection. The spare WTL laser can tune to any wavelength associated with the primary channels.

In the example, shown in FIG. 3a, k spare channels (301-N+1 to 301-N+k) are provided on substrate 311. Accordingly, up to k primary channels from 301-1 to 301-N may be deactivated and replaced by the spare channels. In that case, optical signals TE-N+1 to TE-N+k and TE′-N+1 to TE′-N+K would be received by and detected by a corresponding one of the spare channels.

FIG. 3b shows an example of Rx PIC 300 similar to that shown in FIG. 3a. For example, light from output side S1 of each WTL LO may be provided to a corresponding MMI coupler or splitter. In FIG. 3b, however, light supplied from a second side output S2 of each WTL LO is provided to a corresponding one of selectors 209 via a respective waveguide WG-1 to WG-N+K. The selectors, in turn, selectively supply the received LO light to a combiner, which outputs the light to a wavelength locking and detection circuit (WLL). The structure of operation of the selectors, combiner and WLL are discussed above in connection with FIG. 2e.

FIG. 3c illustrates Rx PIC 300 which is similar to the PIC shown in FIG. 3b. In FIG. 3c, however, a tunable reference laser, which may include a DFB laser, is provided to one of selectors 209, the outputs of which are fed to combiner 315, which may have a similar structure as combiner 207. Combiner 315 has two outputs: the first output supplies a first portion of the selectively input light from selectors 209 to a wavelength detection circuit such as a WLL, and the second output supplies a second portion of the selectively input light from selectors 209 to splitter (MMI-4). The splitter provides a first part of the received light to a delay line interferometer (DLI) and a second part to a 2×4 MMI which has a plurality of outputs, each of which being coupled to a respective one of photodiodes PDs. The DLI includes first and second waveguides, wherein one of the waveguides is longer than the other, and the light supplied by the waveguides will interfere in the 2×4 MMI and at least one of the photodiodes (“DLI PDs”) will have a relatively large-magnitude photodiode (PD) photocurrent slope vs. frequency. The optical outputs from each such locations are separated from each other by ˜90 degrees of phase. By monitoring the photodiode with a high photocurrent slope vs. frequency for a given wavelength, changes in frequency less than the FSR of the DLI, can be monitored to determine and correct frequency errors.

The reference laser may be useful in maintaining a reference between an internal DLI and external etalon(s) for wavelength locking while the WTLs are switching wavelengths. The reference laser may also be monitored by the PD of the DLI with highest slope of PD response and therefore assist in locking the WTL wavelengths. The reference laser wavelength, which may be a tunable DFB laser (e.g., tunable by temperature, current, etc.), for example, may need to be tuned initially and over life to maintain performance, and it may also use the external wavelength locker (e.g. etalon(s)) for a more absolute wavelength calibration.

FIG. 3d illustrates an example in which a TE composite signal output from a polarization beam splitter (not shown) is provided to a first power splitter having at least N+k outputs that are coupled to a respective one of channels 301-1 to 301-N+k. The composite signal includes a plurality of optical signals, each having a different wavelength and may be the TE component of a dense wavelength division multiplexed (DWDM) optical signal. A second power splitter is also provided that receives a second TE′ composite signal output from the polarization beam splitter and rotated by a polarization rotator. The TE′ composite signal may correspond to the TM component of the DWDM optical signal (rotated to TE on the PIC and labeled as TE′ in the figures.) The outputs of the second splitter are also coupled to a respective one of channels 301-1 to 301-N+k. In each channel that has been activated, the received TE light is supplied to a first optical hybrid and the TE′ light is provided to a second optical hybrid in a manner similar to that described above.

In PIC 300 shown in FIG. 3d, the N+k power splitters degrade the signal path photodiode sensitivity by 1/(N+k). A minimum signal power to the photodiodes in the activated channels may be required to achieve minimum received optical signal-to-noise ratio (ROSNR) for receiving particular optical modulation formats at high speeds and over particular optical links. Therefore, depending on the optical system design, an upper limit on the number of primary and spare channels may be necessary to avoid excessive loss.

FIG. 4 shows an example of a transceiver PIC 400 provided on substrate 411 consistent with an additional aspect of the present disclosure. PIC 400 includes a plurality of primary channels 401-1 to 401-N and spare channels 401-N+1 to 401-N+k. Each channel includes both transmit and receive devices so that activated primary and spare channel output modulated optical signals for transmission and receive modulated optical signals for detection are integrated on each channel.

As further shown in FIG. 4, each channel includes a corresponding one of lasers, such as WTL-1 to WTL-N+k. Each WTL has a first output side S1 that provides light to a corresponding MMI coupler, such as MMI couplers MMI1-1 to MMI1-N and MMI1-N+1 to MMI-N+k. These MMI couplers supply CW light to corresponding IQ modulators in a manner similar to that discussed above with reference to FIG. 2a. In addition, light from a second output side S2 of each WTL is provided to a corresponding one of MMI couplers, such as MMI couplers MMI2-1 to MMI2-N and MMI2-N+1 to MM2-N+k. Each output of the MMI2 couplers is provided to corresponding optical hybrid circuit for mixing with incoming modulated optical signals in a manner similar to that discussed above. As further noted above, the optical hybrid circuits supply optical mixing products to corresponding photodiodes, such as the photodiodes in photodiode groups PD1 and PD1′ to PDN and PDN′, and PDN+1 and PDN+1′ to PDN+k and PDN+k′. Each photodiode in each such group generates electrical signals based on the mixing products. The electrical signals, in turn, are subject to further processing to recover data carried by the received optical signals.

Activation and deactivation of channels 401-1 to 401-N+k by control circuitry (not shown in FIG. 4) to facilitate replacement by spare channels is similar to that described above.

It is noted that although specific examples are described above, various features of each example may be combined with features of other examples. For example, the wavelength locking techniques, as well as on-PIC power combining, and splitting discussed above may also be provided on transceiver PIC 400.

Sparing of channels on a PIC has been described above. Consistent with a further aspect of the present disclosure, spare electrical connections to the PIC may also be made to selectively connect to activated working and spare PIC channels.

For example, operational or “good” WTLs and PIC channels may be determined and configured during wafer-level testing (i.e., before a wafer is diced into individual die). Alternatively, good WTLs and PIC channels may be determined during: testing of individual, unmounted PICs (after dicing into individual die), after PICs have been mounted on carriers or interposers, after being connected to driver ASICs, after PICs have been assembled in an analog coherent optics (ACO) sub-assembly that does not contain a DSP, or after PICs have been packaged in digital coherent optics (DCO) sub-assembly that contain DSPs. Sub-assemblies may include modules housing components, as well as disaggregated components. Examples in which sparing is carried out through selective electrical connection to the PIC will next be described with reference to FIGS. 5a-5f.

FIG. 5a illustrates a generalized view of an example of sparing using electrical connections between PIC 500 and application specific integrated circuit (ASIC) 502. PIC 500 may be any of the PICs discussed above that include channels (PIC channels). In the case of a transmitter PIC, each channel includes a modulator. Electrical drive signals may be supplied to such modulators by an ASIC, such as ASIC 502. In addition, if receiver circuitry is provided in PIC 500, photodiodes in PIC 500 may output electrical signals to ASIC 502 based on optical signals received by PIC 500. In that case, ASIC 502 may include circuitry, such as transimpedance amplifiers and other circuits, that process or amplify the electrical signals output from PIC 500. In either case or if the PIC 500 is a transceiver PIC similar to that described above, electrical connections may be required that extend from PIC 500 to ASIC 502 to transmit electrical signals from PIC 500 to ASIC 502. Such electrical connections are shown in the example of FIG. 5a. Here, there are N=6 primary connections F1 to F6 between each of conductors or pads 1 to 6 of Bank A on PIC 500 and a corresponding one of pads or conductors 1 to 6 of Bank B on ASIC 502, and K=1 spare connections. In the event that one of the primary PIC channels associated with pad or conductor 2 is defective or has a fault, the spare channel is electrically coupled to spare pad or conductor 7 of Bank A, which, has N primary and K=1 spare conductors or pads, and primary connection F2 between conductor 2 of Bank A and conductor 2 of Bank B is not made. Rather, actual connections AC1 to AC6 are respectively made between conductor 1 of Bank A to conductor 1 of Bank B, conductor 3 of Bank A to conductor 2 of Bank B, conductor 4 of Bank A to conductor 3 of Bank B, conductor 5 of Bank A to conductor 4 of Bank B, conductor 6 of Bank A to conductor 5 of Bank B, and conductor 7 of Bank A to conductor 6 of Bank B. Accordingly, N=6 (N being the number of channels supported by PIC 500) connections are made to PIC 500.

Although FIG. 5a shows connections between PIC 500 ad ASIC 502, it is understood that electrical connections may be made and sparing of such connections may be provided between the ASIC and a digital signal processor that supplies further electrical signals to and receives further electrical signals from the ASIC.

FIG. 5b shows an example of a module or module package 505 including a PIC having N primary channels and K=1 spare channels (“N+1”) and a corresponding number, N+1, of electrical connections 501 that supply electrical signals, such as Mach-Zehnder driver signals, from ASIC 502 to corresponding Mach-Zehnder modulators circuits on PIC 500. The driver signals, which may be high speed (RF), are generated in response to outputs that are supplied from DSP 506 through connections in a wall of module package 505 and via a radio frequency (RF) fanout 503. RF fanout 503 may include N conductors or RF interconnects 503-1 that are provided on substrate 503-2, which may include glass, silicon, ceramic, or other suitable materials. In one example, some of conductors 503-1 carry a DC signal and others may carry an RF signal. In addition, conductors 503-1 may include an RF cable, wire bond, or a thermocompression bonding connection. In one example, each of N conductors 503-1 connect to a respective one of N inputs, which are selected out of N+k (k=1) inputs (502-1) of ASIC 502. Each of the selected inputs is coupled to or associated with a respective one of operational channels on PIC 500. One of inputs 502-1, however, is associated with one of the PIC channels that is defective or has been deactivated.

Thus, in the example shown in FIG. 5b, any N channels may be selected from the N+1 possible channels.

FIGS. 5c and 5d show examples of RF fanout 503 in greater detail. In FIG. 5c, RF fanout 503 includes ten pads numbered 1 to 10 that receive signals from DSP 506. Each of these pads is connected by a respective one of traces or conductors 503-1 to each of ten of eleven pads (numbered 1 to 11 in FIG. 5c). The selected ten of the eleven pads correspond to ten working or operational channels of PIC 500 (pad 3 is not selected). Accordingly, FIG. 5c illustrates an 11-choose-10 configuration and the total number of fanout types is 11 since any one of the 11 possible paths may be skipped.

FIG. 5d shows another example in which each of the ten pads that receive outputs from the DSP connect to a corresponding one of ten pads selected from 12 pads (numbered 1 to 12 in FIG. 5d) that connect to the ASIC. Here also, the selected ten pads correspond to ten working or operational channels of PIC 500 (pads 3 and 8 are not selected). Thus, FIG. 5d illustrates a 12-choose-10 configuration, but the total number of fanout types in this example is much larger, 66.

Therefore, as shown in FIG. 5c, for k=1 and N=10, there are 11!/(10!1!)=11 possible RF fanout types or fanout configurations, each of which having a different combination of connected DSP coupled and ASIC coupled RF fanout pads. In FIG. 5d, however, when k=2 and N=10, there are 12!/(10!2!)=66 possible RF fanout types or configurations. Accordingly, for large enough k and N, the cost and complexity associated with the resulting high number of RF fanout types may be excessive.

FIG. 5e shows a plan view of an example of a two-level fanout having fewer associated fanout configurations and FIG. 5f shows a cross-sectional view of the two-level fanout shown in FIG. 5e. In particular, FIG. 5e shows ASIC 502 having pads 510 that are numbered from 1 to 10 in the drawing. RF fanout 509, like RF fanout 503 discussed above, provides connections such as RF and DC connections to/from ASIC 502. RF fanout 509, however, may include a bottom or lower layer 509-1 and an upper or top layer 509-2 provided on lower layer 509-1, so that the RF fanout 509 has stepped portions 525-1 and 525-2 (see FIG. 5f). Lower layer may have first pads 512 (numbered 1 to 10 in FIG. 5e) that connect to pads 510 of ASIC 502 and second pads 518 that connect to selected pads 520 provided on package 521 for interfacing with (e.g., transmitting to/receiving signals from) DSP 506. Pads 512 may be provided along a first edge or side of bottom layer 509-1 and pads 518 may be provided along a second edge or side of bottom layer 509-1.

As further shown in FIG. 5e, top layer 509-2 of RF fanout 509 may include first pads 514 and second pads 517. Pads 514 may be provided along a first edge or side of top layer 509-2 and pads 517 may be provided along a second edge or side of top layer 509-2.

In the example shown in FIG. 5e, pad 3 of ASIC pads 510 is deselected because PIC channel 3 associated with pad 3 is defective or include a fault. In order to connect the remaining ASIC pads 510 to DSP 506, selected wire bonds 511 are provided, such as wire bond 511-1 that connects one of ASIC pads 510 (e.g., ASIC pad 1) with one of first bottom layer pads 512. The connected first bottom layer pads 512 are further connected to a respective one of second bottom layer pads 518 by a respective one of conductors or traces 515. Additional wire bonds, such as wire bond 511-2, may provide a connection from selected ones of ASIC pads 510 to a corresponding one of first upper layer pads 514. Each of upper layer pads 514, in turn, is connected to a respective one of second upper layer pads 517, selected ones of which may be connected to corresponding package pads 520 by additional bond wires 519, such as bond wire 519-2.

In the example shown in FIGS. 5e and 5f, the number of required unique parts is reduced because the same RF fanout of bottom layer 509-1 and top layer 509-2 may be used and selection/deselection of spares may be carried by selective wire bonding to the upper and lower layer pads. Accordingly, for example, only two types of RF fanouts (one for the bottom layer 509-1 and one for the top layer 509-2) are required rather than 11 different types for the N=10 and k=1 single layer interposer described above. This may result in lower fixed cost but higher variable cost.

FIGS. 5g and 5h show plan and cross-sectional views, respectively, of an alternative arrangement in which wall 530 of module package 505 has multiple levels or is stepped instead of providing a multilevel fanout as described above. As shown in these figures, ASIC pads 510 may be connected to corresponding first pads 531 on carrier or single layer fanout 532 via wire bonds 511. Carrier 532 includes a substrate 532-2 and traces or conductors 532-1 provided on substrate 532-2. Traces 532-1 connect each of first pads 531 to a corresponding one of second pads 533. Additional wire bonds 534, such as wire bond 534-1, connect selected second carrier pads 533 to first package pads 535 provided on a lower shelf 530-1 of package wall 530. Other wire bonds 534, such as wire bond 534-2, connect selected carrier pads 533 to second package pads 536 on upper package shelf 530-2. Collectively, the upper (530-2) and lower (530-1) shelves of package wall 530 constitute a stepped portion 540 of module package 505.

As further shown in FIG. 5g, traces or conductors 537 may connect each of first package pads 535 to a corresponding one of package I/O pads 539 (for further connection to DSP 506), and traces or conductors 538 may connect each of second package pads 536 to a corresponding one of package I/O pads 539.

In the example shown in FIG. 5g, ASIC pad 4 (of ASIC pads 510) and second carrier pad 4 (of second carrier pads 533), corresponding to a defective or faulty PIC channel, are deselected or skipped in the wire bonding process. Selected wire bonds 534 connect carrier pads 1 to 3 (of second carrier pads 533), corresponding to active PIC channels 1 to 3, to respective lower shelf pads 535 of package wall 530, and other wire bonds 534 connect carrier pads 5 to 7, corresponding to active PIC channels 5 to 7, to respective upper shelf pads 536 of package wall 530. In the example shown in FIG. 5g, package pads 539 associated with the same channel and the same signal may be connected internally in the package. In addition, two set of RF traces may share the same package I/O pad 539.

Design flexibility, cost and RF performance may be considered in implementing the fanout examples discussed above.

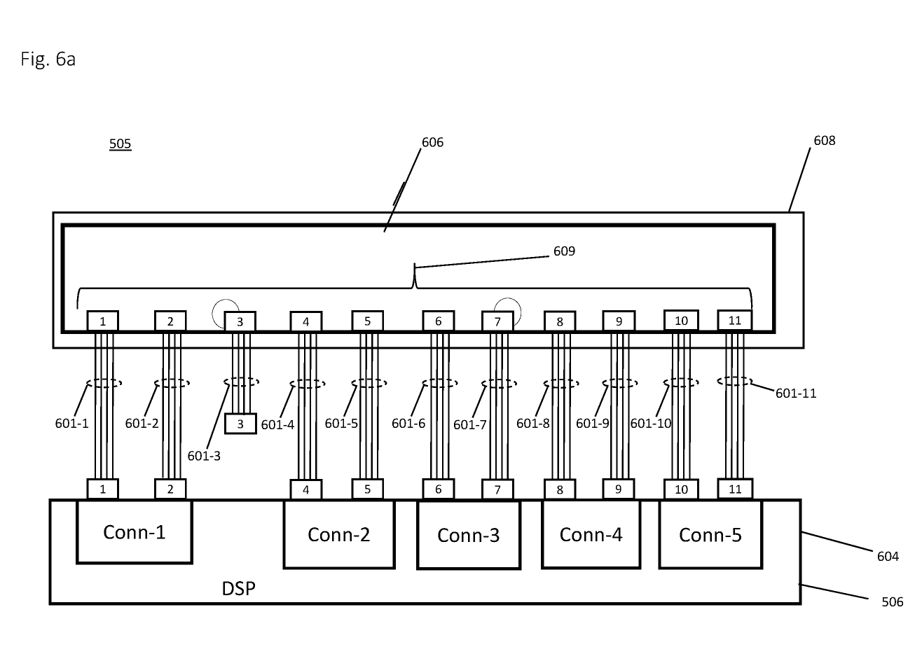

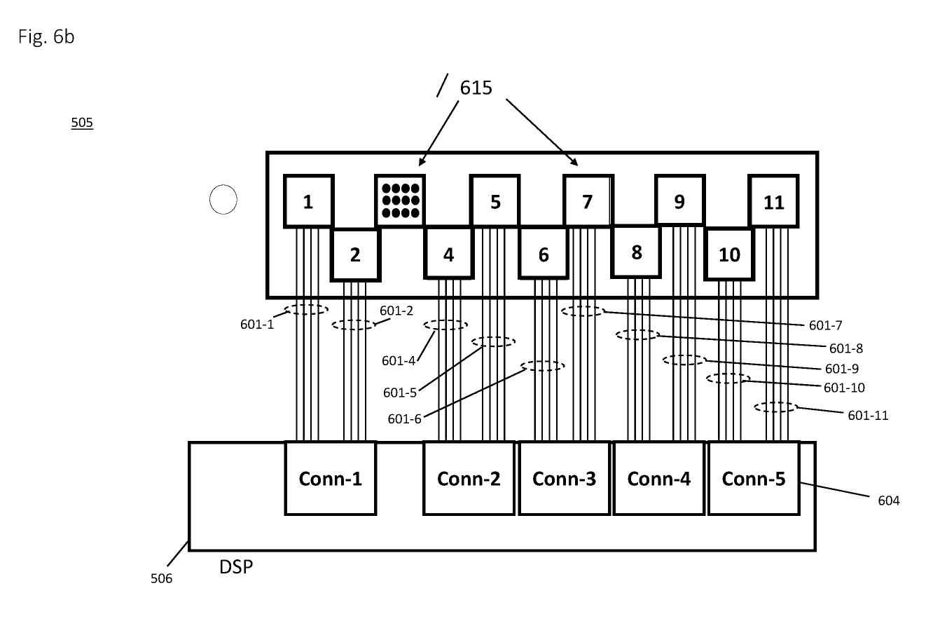

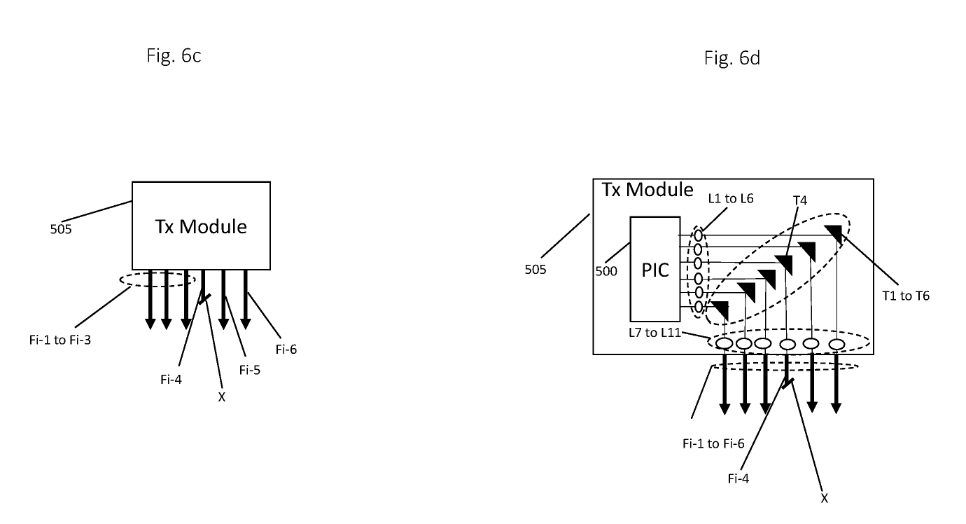

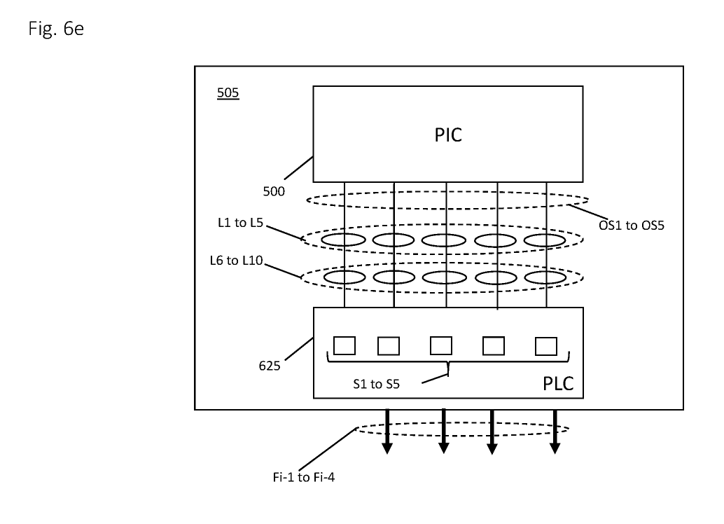

Selection of N channels may also occur external to the PIC module. In one example, RF cables to connect a subset N of the N+k channels from module 505 to DSP 506 for both receiver and transmitter implementations. In particular, as shown in the example illustrated in FIG. 6A, RF cables 601, which may include twinaxial cable assemblies, including cables having two inner conductors, may connect to pads or conductors (not shown in FIG. 6a) of module package 505 to corresponding conductors 603, such as pluggable inserts or selective solder connections, on DSP 506. Receptacles 604 (Conn-1 to Conn-5) may connect each of conductors 603 to circuitry included in DSP 506. In addition, module package 505 may include mini-printed circuit board 606 mounted in a frame (not shown). Mini-printed circuit board 606 may be provide on a substrate or interposer 608.

In the example shown in FIG. 6a, each group of RF cables 601-1 to 601-11 is attached to a respective one of N+k (e.g., 10+1=11) RF connections 609 of module package 505, but only N RF cable groups 601-1, 601-2, and 601-4 to 601-11 are attached to conductors 603 of DSP 506. Each RF cable group and RF connection may be associated with a particular PIC channel. Accordingly, by selectively making connections to DSP 506, as in FIG. 6a, one or more spare channels may be coupled to DSP 506 in the event one or more of the primary PIC channels is determined to be defective. Although ten connections are selected from eleven in FIG. 6a, it is understood that similar selection of RF connections may be applied to other configurations in which, for example, 12 connections are selected from 13, 10 connections are selected from 12, and six connections are selected from seven.

In FIG. 6b, each of RF cable groups 601-1, 601-2, and 601-4 to 601-11 (collectively referred to with respect to FIG. 6b as “RF cable groups 601”) includes, for example, so called twinax or twinaxial cables having first and second inner conductors. One end of each cable group 601 may be connected to DSP 506 with surface mount (SMT RF) connectors 604 (Conn-1 to Conn-5). On the other end cable group 601, each is connected to module package 505 through a respective one of land grid array (LGA) pads 615 (e.g., LGA pads 1, 2, and 4-11 in FIG. 6b). LGA pad 3 (of pads 615), however, is not connected because the PIC channel, e.g., channel 3, associated with LGA pad 3 is defective. Thus, RF cables 601 are only attached to N module RF connections, e.g., LGA pads 615, and N connections to DSP 506.

In FIG. 6b, RF cables 601 may be attached to LGA pads 615 by direct attachment with solder, for example. Moreover, LGA pads may be provided on a substrate, such as an interposer, having traces (not shown) and RF cables 601 may be attached to such substrate.

Consistent with another aspect of the present disclosure, all channels may be connected by RF cables from the module to DSP 506, and selection if made via controls to DSP 506.

FIG. 6c shows an example in which module 505, which in this example is a transmitter (Tx) module. Here, five optical fibers Fi-1 to Fi-6 are connected to module 505. Module 505 may include PIC 500, which may include N primary lasers and k spare lasers. Here, N=5 and k=1 Each of the spare lasers is widely tunable, as noted above. As further noted above, PIC 500 includes N primary channels, each of which including a corresponding one of the N lasers, and k spare channels, each of which including a corresponding one of the k lasers. In the example shown in FIG. 6c, N+k=6 optical fibers are connected to module 505 during assembly. Each fiber is connected to a respective one of the N=6 channels. The channels are tested, and, if one is determined to be faulty, the fiber associated with or connected to that channel is not selected, such that no optical connection is made to the de-selected fiber and the fiber is terminated with a termination X. Alternatively, if all six channels meet a given performance threshold, those fibers connected to the best performing channels are selected, and the channel with the lowest performance is deselected. In the example shown in FIG. 6c, channel 4 may be identified as the faulty channel, and, therefore, fiber Fi-4 may be terminated.

FIG. 6d shows an example similar to that shown in FIG. 6c. In FIG. 6d, however, rather than terminating the fiber associated with a defective PIC channel, free space optics including a lens array or lenses L1 to L6, turning mirrors T1 to T6, and lens array or lenses L6 to L10 may be provided that are optically coupled to PIC 500. During assembly, the lowest performing channel may be identified, as noted above, and the fiber connected to such lowest performing channel may be terminated with a termination X.

In an alternative example, the turning mirrors may be omitted and one or more of lenses L1 to L6 and L6 to L910 may be moved, positioned, or rotated to direct modulated optical signals from the spare channel(s) to one or more output fibers Fi-1 to Fi-5.

FIG. 6e shows another example similar to that shown in FIGS. 6c and 6d. As shown in FIG. 6e first and second lens arrays L1 to L5 and L6 to L10 are provided that direct light or optical signals OS1 to OS4 output from PIC 500 to planar lightwave circuit (PLC) 625. Switches S1 to S5, which may be optical switches, may direct OS1 to OS4, including light output from a spare PIC channel, to a respective output, such as a corresponding one of optical fibers Fi-1 to Fi-4. Light, to the extent output from a defective channel, is not directed to an output optical fiber by one or more of switches S1 to S5.

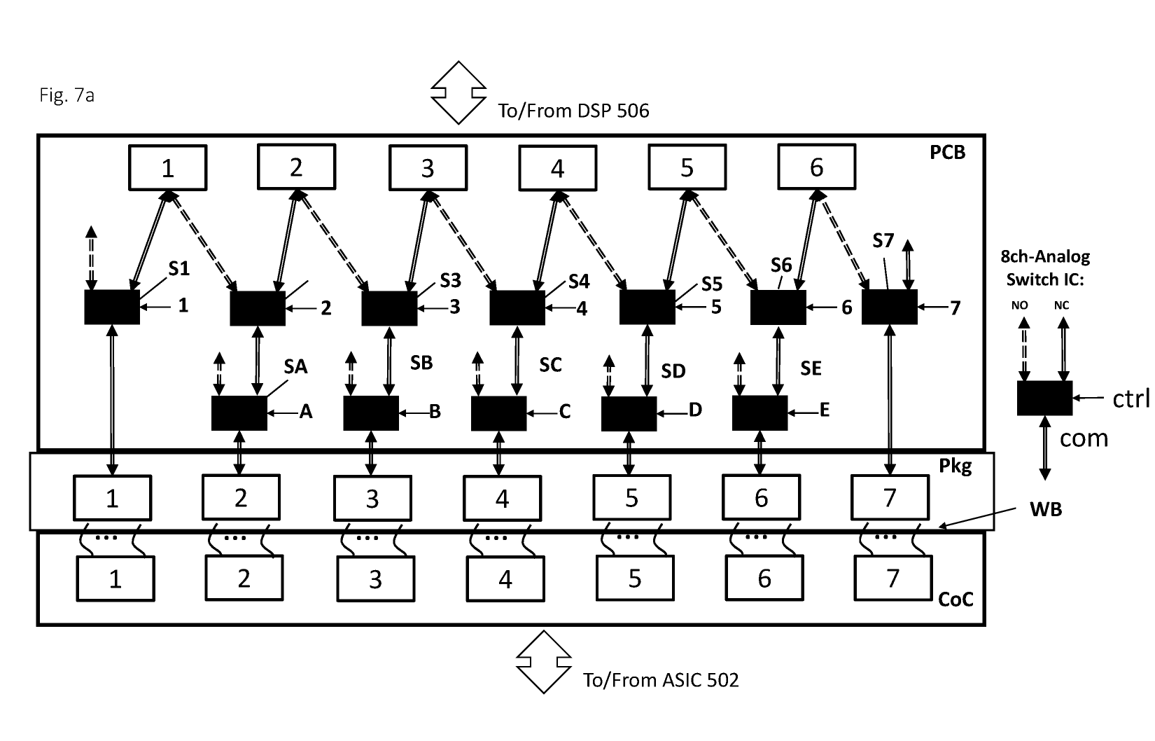

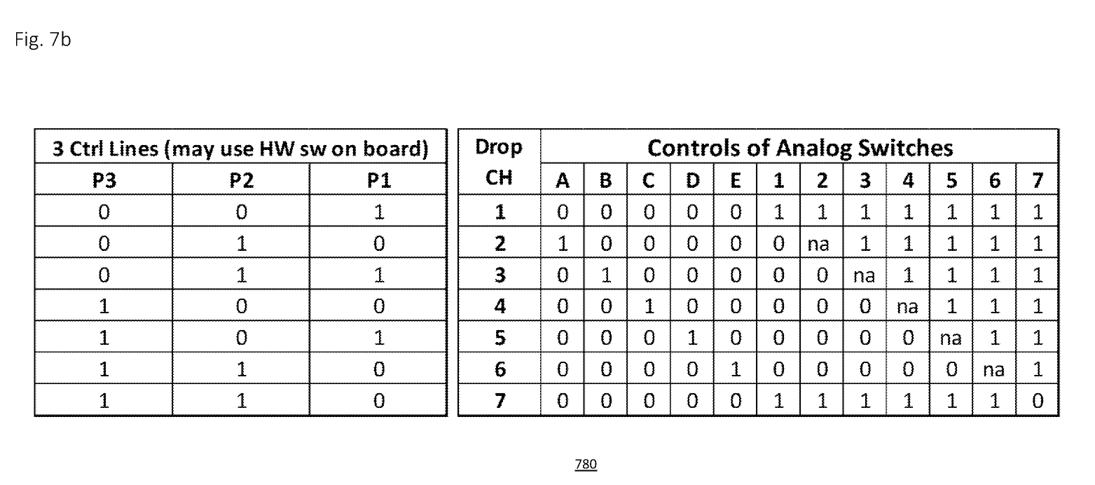

FIG. 7a illustrates an example in which analog electrical switches are provided to selectively direct electrical signals to/from connections associated with working PIC channels, while disabling or deactivating PIC channels that include a fault. As shown in FIG. 7a, electrical signals supplied from DSP 506, for example, may be input pads 1 to 6 on a printed circuit board (PCB). The signals may next be supplied to a first stage of switches including switches S1 to S7, which in turn, selectively supply the signals to a second stage of switches including switches SA to SE. The signals may next be supplied to package pads 1 to 7 and to ASIC pads 1 to 7 via wire bonds WB. Signals output from ASIC 502 may follow the reverse flow as that described above.

Switches S1 to S7 may be controlled based on control signals 1 to 7, respectively, and switches SA to SE may be controlled based on controls signals A to E, respectively.

The first and second stages of switches described above permit selection of six connections or channels with an 8-channel analog switch integrated circuit. Accordingly, based on a determination that one of the PIC channels is defective or fault, switches S1 to S7 and SA to SE may be configured such that one or more of the faulty channels are deactivated or the inputs/outputs thereof are deselected, while inputs/outputs of a corresponding number of spare channels are activated to supply electrical signals to the ASIC, for example, and receive electrical signals from the ASIC.

FIG. 7b illustrates an example of a truth table 780 for the control signals 1 to 7 and A to E in FIG. 7a. The circuitry for controlling the switches in FIG. 7a and for generating such control signals may be implemented with a field programmable gate array (FPGA) circuit based on control lines P1 to P3. Truth table identifies appropriate signals for dropping, deactivating electrical connections associated with a fault PIC channel.

Consistent with a further aspect of the present disclosure, modulator (e.g., Mach-Zehnder modulators (MZMs) on PIC 500) biasing selections may be made through a serial-parallel-interface (SPI) interface external to module 505 (in DSP 506, for example) or internal to 505 module (through ASIC 502, e.g., an MZM driver circuit).

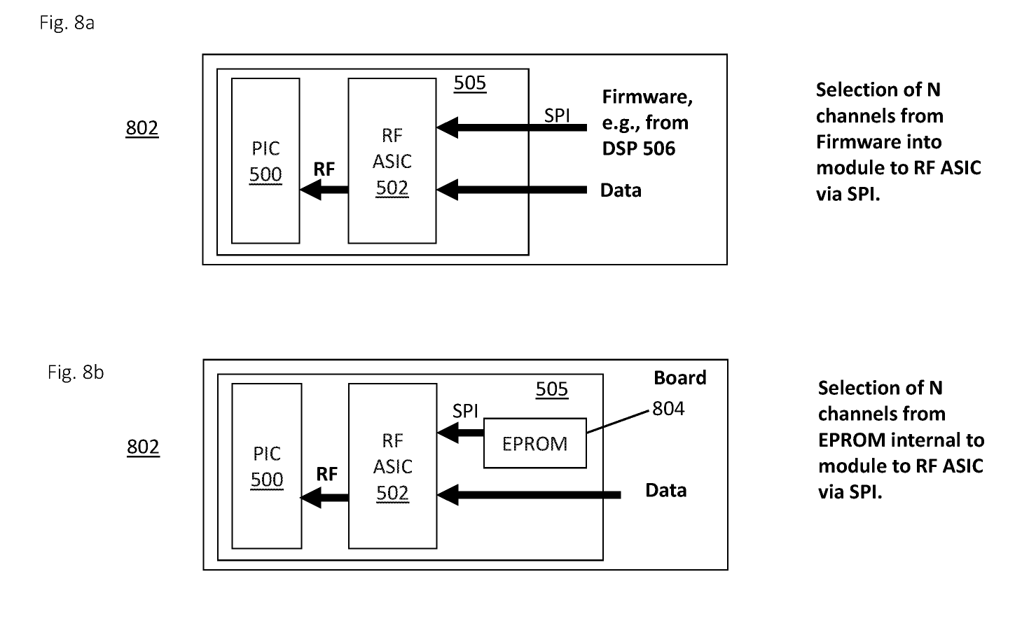

For example, as shown in FIG. 8a, ASIC 502 may receive data or digital electrical signals, and based on such data, ASIC 502 may generate high speed (RF) analog signals (driver signals) that are input to the modulators in the channels of PIC 500. PIC 500, as noted above, may have working or primary channels and one or more spare channels. SPI signals supplied from firmware in DSP 506, for example, may also be supplied to ASIC 502. Based on such signals, circuitry in ASIC 502 may turn-off or disable the modulator or modulators in the faulty working channels, such that the faulty channels do not output optical signals. Moreover, based on further SPI signals, such circuitry in ASIC 502 may further turn on or enable modulators in the spare channels, such that the spare channels are activated to supply modulated optical signals in place of the faulty working channel. Module 505 may be provided on board 802 in FIG. 8a.

The example shown in FIG. 8b is similar to that shown in FIG. 8a. In FIG. 8b, however, SPI signals are supplied from an integrated circuit, such as an electrically programmable read only memory (EPROM) 804 that is also provided on board 802.

It is noted that fewer than N PIC channels may be activated or fewer than N electrical connections may be made to the PIC so that channel counts may be tailored for applications in which a low number of channels or optical signals is desired.

In summary, there are various ways to architect and select N+k channels from N options of channels and/or electrical connections. All N+k channels may be located within or outside of the module or module package and selected by way of WTL, DC element or RF controls. Alternately, N used channels may be located within or outside of the module and controlled by WTL, DC element or RF controls. Regardless of where the channels are located (within or outside of the module), selection of N channels from N+k channels may be internal or external to the module based on such controls.

Other embodiments will be apparent to those skilled in the art from consideration of the specification. It is intended that the specification and examples be considered as exemplary only, with a true scope and spirit of the invention being indicated by the following claims.

What is claimed is:

1. An apparatus, comprising:
a substrate;
N channels provided on the substrate, each of which including a corresponding one of a first plurality of lasers, N being an integer;
a spare channel provided on the substrate, the spare channel including a second laser that is widely tunable, collectively, the N channels and the spare channel being a set of channels; and
N optical connections, each of which being coupled to a respective one of a plurality of active channels, the plurality of active channels being selected from the set of channels, such that each of the plurality of active channels supplies or receives a respective one of N modulated optical signals via a corresponding one of the N optical connections, wherein a remaining channel of the set of channels is not coupled to any of the N optical connections, the remaining channel being de-activated, such that the remaining channel does not supply or receive light that has been modulated to carry data.

2. An apparatus in accordance with claim 1, wherein each of the first plurality of lasers is widely tunable.

3. An apparatus in accordance with claim 1, wherein the second laser is tunable over the C-band.

4. An apparatus in accordance with claim 1, wherein the second laser is tunable over the L-band.

5. An apparatus in accordance with claim 1, wherein the second laser is tunable over the S-band.

6. An apparatus in accordance with claim 1, wherein the second laser is tunable over the E-band.

7. An apparatus in accordance with claim 1, wherein the second laser is tunable over the O-band.

8. An apparatus in accordance with claim 2, further including:
a first plurality of optical devices provided on the substrate;
a second plurality of optical devices provided on the substrate;
a third optical device provided on the substrate; and
a fourth optical device provided on the substrate;
N first couplers, each of which having an input being coupled to an output of a corresponding one of the first plurality of lasers, each of the N first couplers having a first output coupled to a corresponding one of the first plurality of optical devices and a second output coupled to a corresponding one of the second plurality of optical devices, each of the N first couplers being provided on the substrate; and
a second coupler coupled to the second laser, the second coupler having an input coupled to an output of the second laser, and first and second outputs, the first output of the second coupler being coupled to the third optical device and the second output being coupled to the fourth optical device, the second optical coupler being provided on the substrate.

9. An apparatus in accordance with claim 8, wherein each of the first plurality of lasers has first and second outputs, the first output of each of a plurality of first lasers is coupled to a corresponding one of the plurality of first optical devices, the second laser has first and second outputs, the first output of the second laser is coupled to the second optical device, the apparatus further including:
a first plurality selectors provided on the substrate, the second output of each of the first plurality of lasers being coupled to a corresponding one of the first plurality selectors, each of the first plurality of selectors selectively supplying light from a respective one of the first plurality of lasers to a control circuit that monitors a wavelength of said light; and
a second selector provided on the substrate, the second output of the second laser being coupled to the second selector, the second selector selectively supplying light from the second laser to the control circuit.

10. An apparatus in accordance with claim 9, wherein each of the first plurality of selectors and the second selector includes an optical amplitude adjusting device, the amplitude adjusting device including at least one of: a Mach-Zehnder interferometer, a variable optical attenuator (VOA), and a semiconductor optical amplifier (SOA).

11. An apparatus in accordance with claim 2, wherein each of the first plurality of lasers has first and second outputs, the first output of each of the first plurality of lasers is coupled to a corresponding one of the first plurality of optical devices, and the second laser has first and second outputs, the first output of the second laser is coupled to a the second optical device, the apparatus further including:
a first plurality of taps provided on the substrate, each of the plurality of taps has an input coupled to a corresponding second output of each of the first plurality of lasers and first and second outputs, the first output being coupled to a corresponding one of the first plurality of optical devices;
a second tap provided on the substrate, the second tap being coupled to the second output the second laser and first and second outputs, the first output of the second tap being coupled to the second optical device;
a first plurality selectors provided on the substrate, the second output of each of the first plurality of taps being coupled to a corresponding one of the first plurality selectors, each of the first plurality of selectors selectively supplying light from a respective one of the first plurality of lasers to a control circuit that monitors a wavelength of said light; and
a second selector provided on the substrate, the second output of the second tap being coupled to the second selector, the second selector selectively supplying light from the second laser to the control circuit.

12. An apparatus, comprising:
a substrate;
N channels provided on the substrate, each of which including a corresponding one of a first plurality of lasers and a corresponding one of a plurality of first optical devices, N being an integer;
a spare channel provided on the substrate, the spare channel including a second laser, which is widely tunable;
a second optical device provided on the substrate, the second optical device being coupled to a first output of the second laser, the second optical device having a first output and a second output;
a third optical device provided on the substrate, the third optical device being coupled to a second output of the second laser, the third optical device having a first output and a second output;
a first shutter provided on the substrate, the first shutter being coupled to the first output of the second optical device;
a second shutter provided on the substrate, the second shutter being coupled to the second output of the second optical device;
a third shutter provided on the substrate, the third shutter being coupled to the first output of the third optical device;
a fourth shutter provided on the substrate, the fourth shutter being coupled to the second output of the third optical device; and
first, second, third, and fourth multiplexers, each of which being coupled to a corresponding one of the first, second, third, and fourth shutters, the first, second, third, and fourth multiplexers being provided on the substrate.

13. An apparatus in accordance with claim 12, wherein each of the first, second, third, and fourth shutters includes an optical amplitude adjusting device, the optical amplitude adjusting device including at least one of: a Mach-Zehnder interferometer, a variable optical attenuator (VOA), and a semiconductor optical amplifier (SOA).

14. An apparatus, comprising:
a substrate;
N channels, each of which including a corresponding one of N first lasers tunable over a C-band and N second lasers tunable over an L-band, each of the N channels including a corresponding one of a plurality of first optical devices and a corresponding one of a plurality of second optical devices, each of the N channels being provided on the substrate;
a spare channel including a third laser tunable over the C-band, a fourth laser tunable over the L-band, a third optical device, and a fourth optical device, the first spare channel being provided on the substrate; and
circuitry that deactivates one of the N first or one of the N second laser channels and activates the third or fourth laser of the spare channel when a fault is detected in one of the N channels including said one of the N first lasers or N second lasers.

15. An apparatus in accordance with claim 14, further comprising:
a plurality of first couplers provided on the substrate, each of the plurality of first couplers having a first input coupled to a respective one of the N first lasers and a second input coupled to a respective one of the N second lasers, each of the plurality of first couplers having a first output coupled to a respective one of the plurality of first optical devices and a second output coupled to a respective one of the plurality of second optical devices; and
a second coupler provided on the substrate, the second coupler having a first input coupled to the third laser and a second input coupled to the fourth laser, the second coupler having a first output coupled to the third optical device and a second output coupled to the fourth optical device.

16. An apparatus in accordance with claim 15, wherein each of the plurality of first couplers and the second couplers includes a multimode interference (MMI) coupler.

17. An apparatus in accordance with claim 2, wherein each of the N channels includes a corresponding one of a plurality of first optical devices and the second channel includes a second optical device, each of the first optical devices and the second optical device includes a Mach-Zehnder modulator.

18. An apparatus in accordance with claim 8, wherein each of the plurality of first optical devices includes a corresponding one of a first plurality of IQ modulators, each of the plurality of second optical devices includes a corresponding one of a second plurality of IQ modulators, the third optical device includes a third IQ modulator and the fourth optical device includes a fourth IQ modulator.

19. An apparatus in accordance with claim 18, further including:
a first plurality of semiconductor optical amplifiers (SOAs) provided on the substrate, being coupled to a corresponding one of the first plurality of IQ modulators;
a second plurality of SOAs, each of which being coupled to a corresponding one of the second plurality of IQ modulators;
a third SOA coupled to the third IQ modulator; and
a fourth SOA coupled to the fourth IQ modulator, each of the first plurality of SOAs, the second plurality of SOAs, the third SOA and the fourth is provided on the substrate.

20. An apparatus in accordance with claim 2, further comprising a multiplexer provided on the substrate, the multiplexer receiving at least some of the N modulated optical signals.

21. An apparatus in accordance with claim 2, further including:
a first multiplexer provided on the substrate, the first multiplexer having a plurality of inputs, each of which being coupled to a respective one of first outputs of the N channels and the spare channel; and
a second multiplexer provided on the substrate, the second multiplexer having a plurality of inputs, each of which being coupled to a respective one of second outputs of the N channels and the spare channel.

22. An apparatus in accordance with claim 18, wherein the N modulated optical signals includes N−1 modulated optical signals which constitute first optical signals, and a second optical signal, each of the first optical signals being supplied by a respective one of the first plurality of IQ modulators, and the second optical signal being supplied by the third IQ modulator, each of the first optical signals and the second optical signal having a first polarization,
each of third optical signals being supplied by a respective one of the second plurality of IQ modulators and the fourth IQ modulator supplying a fourth optical signal, each of the third optical signals and the fourth optical signal having the first polarization, the apparatus further comprising:
a polarization rotator receiving the third optical signals and the fourth optical signal, the polarization rotator rotating the first polarization of the third optical signals and the fourth optical signals, such that the third optical signals and the fourth optical signals have a second polarization that is substantially orthogonal to the first polarization.

23. An apparatus in accordance with claim 8, wherein each of the first plurality of lasers includes a corresponding one of a plurality of first local oscillator (LO) lasers, and the second laser is a second LO laser.

24. An apparatus in accordance with claim 23, wherein each of the first plurality of optical devices includes a corresponding one of a first plurality of optical hybrids, each of the second plurality of optical devices includes a second plurality of optical hybrids, the third optical device includes a third optical hybrid, and the fourth optical device includes a fourth optical hybrid.

25. An apparatus in accordance with claim 23, wherein the N modulated optical signals includes N−1 modulated optical signals which constitute first optical signals, and a second optical signal, each of the first optical signals being detected by a respective one of N−1 of the N channels, and the second optical signal being detected by the spare channel, each of the first optical signals and the second optical signal having a first polarization,
each of third optical signals being detected by a respective one of said N−1 channels, and the fourth optical signal being detected by the spare channel, each of the third optical signals and the fourth optical signal having the first polarization, the apparatus further comprising:
a polarization rotator receiving the third optical signals and the fourth optical signal, the polarization rotator rotating the first polarization of the third optical signals and the fourth optical signals, such that the third optical signals and the fourth optical signals have a second polarization that is substantially orthogonal to the first polarization.

26. An apparatus in accordance with claim 24, further including:
a first plurality of groups of photodiodes, each of which being coupled to a corresponding one of the first plurality of optical hybrid circuits;
a second plurality of groups of photodiodes, each of which being coupled to a corresponding one of the second plurality of optical hybrid circuits;
a third group of photodiodes being coupled to the third optical hybrid circuit; and
a fourth group of photodiodes being coupled to the fourth optical hybrid circuit,
wherein each of the N channels includes a corresponding one of the first plurality of groups of photodiodes and a corresponding one of the second plurality of groups of photodiodes, and the spare channel includes the third group of photodiodes and the fourth group of photodiodes.

27. An apparatus in accordance with 24, wherein the N modulated optical signals includes N−1 modulated optical signals which constitute first optical signals, and a second optical signal, each of the first optical signals being detected by a respective one of N−1 of the N channels, and the second optical signal being detected by the spare channel, each of third optical signals being detected by a respective one of said N−1 channels of the N channels, and the fourth optical signal being detected by the spare channel, the apparatus further including:
a first splitter provided on the substrate, the first optical signals and the second optical signal being supplied on a first optical communication path to an input of the first splitter, the first splitter having N+k outputs, N outputs of the N+k outputs being coupled to a respective one of the first plurality of optical hybrid circuits and remaining outputs of the N+k outputs being coupled to the third optical hybrid circuit, k being an integer; and
a second splitter provided on the substrate, the third optical signals and the fourth optical signal being supplied on a second optical communication path to an input of the second splitter, the second splitter having N+k outputs, N outputs of the N+k outputs of the second splitter being coupled to a respective one of the third plurality of optical hybrid circuits and the remaining outputs of the N+k outputs of the second splitter being coupled to the fourth optical hybrid circuit.

28. An apparatus in accordance with claim 8, wherein each of the first plurality of optical devices includes a corresponding one of a first plurality of IQ modulators, each of the second plurality of optical devices includes a second plurality of IQ modulators, the third optical device includes a third IQ modulator and the fourth optical device includes a fourth IQ modulator, the apparatus, further including:
N third couplers provided on the substrate, each of the N third couplers having an input coupled to a second output of a corresponding one of the first plurality of lasers;
a fourth coupler provided on the substrate, the fourth coupler having an input coupled to a second output of the second laser;
a first plurality of optical hybrids provided on the substrate;
a second plurality of optical hybrids provided on the substrate;
a third optical hybrid provided on the substrate; and
a fourth optical hybrid provided on the substrate,
wherein the output of the corresponding one of the plurality of lasers is a first output, each of the first plurality of IQ modulators being coupled to a respective first output of each of the N first couplers, and each of the second plurality of IQ modulators being coupled to a respective second output of each of the N first couplers,
each of the N third couplers having a first output coupled to a corresponding one of the first plurality of optical hybrids and a second output coupled to a corresponding one of the second plurality of optical hybrids, and
the first output of the second coupler being coupled to the third optical hybrid and the second output being coupled to the fourth optical hybrid.

29. An apparatus in accordance with claim 28, further including:
a first plurality of groups of photodiodes provided on the substrate, each group in the first plurality of groups of photodiodes being coupled to a corresponding one of the first plurality of optical hybrid circuits; and
a second plurality of groups of photodiodes provided on the substrate, each group in the second plurality of groups of photodiodes being coupled to a corresponding one of the third plurality of optical hybrid circuits.

30. An apparatus in accordance with claim 1, wherein the substrate is a monolithic substrate.

31. An apparatus in accordance with claim 12, wherein the substrate is a monolithic substrate.

32. An apparatus in accordance with claim 14, wherein the substrate is a monolithic substrate.

33. An apparatus in accordance with claim 2, further including:
k spare channels including the spare channel, k, being an integer greater than 1, the k spare channels being provided on the substrate, each of the k spare channels including a corresponding one of a second plurality of lasers, the second laser being included in the second plurality of lasers, each of the second plurality of lasers being widely tunable, wherein the spare channel is a first spare channel, said circuitry selectively activates a second spare channel included in the k spare channels, and deactivates a second one of the N channels, when a fault is detected in said second one of the N channels.

34. An apparatus in accordance with claim 10, wherein the optically attenuating device is selected from the group consisting of: a variable optical attenuator (VOA), an SOA, and a Mach-Zehnder interferometer.

35. An apparatus in accordance with claim 13, wherein the optically attenuating device is selected from the group consisting of: a variable optical attenuator (VOA), an SOA, and a Mach-Zehnder interferometer.

36. An apparatus, comprising:
a substrate;
N channels provided on the substrate, each of which including a corresponding one of a first plurality of lasers and a corresponding one of a first plurality of modulators, N being an integer greater than 1;
k spare channels provided on the substrate, each of which including a corresponding one of a second plurality of lasers and a second plurality of modulators, each of the second plurality of lasers being widely tunable, k being an integer greater than 1, collectively the N channels and the k spare channels being a set of channels; and
N optical connections, each of which being coupled to a respective one of a plurality of active channels, the plurality of active channels being selected from the set of channels, such that each of the plurality of active channels supplies a respective one of N modulated optical signals via a corresponding one of the N optical connections, wherein remaining channels of the set of channels are not coupled to any of the N optical connections, the remaining channels being de-activated, such that the remaining channels do not supply light that has been modulated to carry data.

37. An apparatus, comprising:
a substrate;
N channels provided on the substrate, each of which including a corresponding one of a first plurality of local oscillator (LO) lasers, a corresponding one of a first plurality of optical hybrid circuits, and a corresponding one of a second plurality of optical hybrid circuits, N being an integer;
k spare channels provided on the substrate, each of which including a corresponding one of a second plurality of LO lasers, a corresponding one of a third plurality of optical hybrid circuits, and a corresponding one of a fourth plurality of optical hybrid circuits, each of the second plurality of LO lasers being widely tunable, k being an integer greater than 1, collectively, the N channels and the k spare channels being a set of channels; and
N optical connections, each of which being coupled to a respective one of a plurality of active channels, the plurality of active channels being selected from the set of channels, such that each of the plurality of active channels receives a respective one of N modulated optical signals via a corresponding one of the N optical connections, wherein remaining channels of the set of channels are not coupled to any of the N optical connections, the remaining channels being de-activated, such that the remaining channels do not detect light that has been modulated to carry data.

38. An apparatus, comprising:
a substrate;
N first lasers provided on the substrate, each of the N first lasers having a first side and a second side, N being an integer;
a first plurality of modulators, each of which being coupled to the first side of each of the N first lasers, the first plurality of modulators being provided on the substrate;
a second plurality of modulators, each of which being coupled to the first side of each of the N first lasers, the second plurality of modulators being provided on the substrate;
a first plurality of optical hybrid circuits, each of which being coupled to the second side of each of the N first lasers, the first plurality of optical hybrid circuits being provided on the substrate;
a second plurality of optical hybrid circuits, each of which being coupled to the second side of each of the N first lasers, the second plurality of optical hybrid circuits being provided on the substrate;
k second lasers provided on the substrate, each of the k lasers being widely tunable and having a first side and a second side, k being an integer;
a third plurality of modulators, each of which being coupled to the first side of each of the k second lasers, the third plurality of modulators being provided on the substrate;
a fourth plurality of modulators, each of which being coupled to the first side of each of the k second lasers, the second plurality of modulators being provided on the substrate;
a third plurality of optical hybrid circuits, each of which being coupled to the second side of each of the k second lasers, the first plurality of optical hybrid circuits being provided on the substrate;
a fourth plurality of optical hybrid circuits, each of which being coupled to the second side of each of the k second lasers, the second plurality of optical hybrid circuits being provided on the substrate,
wherein each of N first channels includes:
a corresponding one of the first plurality of modulators, a corresponding one of the second plurality of modulators, a corresponding one of the N first lasers, a corresponding one of the first plurality of optical hybrid circuits, and a corresponding one of the second plurality of optical hybrid circuits, and
each of k second channels includes:
a corresponding one of the third plurality of modulators, a corresponding one of the fourth plurality of modulators, a corresponding one of the k second lasers, a corresponding one of the third plurality of optical hybrid circuits, and a corresponding one of the fourth plurality of optical hybrid circuits, collectively, the N channels and the k spare channels being a set of channels; and
first N optical connections, each of which being coupled to a respective one of a plurality of active channels, and second N optical connections, each of which being coupled to a corresponding one of the plurality of active channels, the plurality of active channels being selected from the set of channels, such that each of the plurality of active channels supplies a respective one of first N modulated optical signals via a corresponding one of the first N optical connections and each of the plurality of active channels receives a respective one of second N modulated optical signals via a corresponding one of the second N optical connections,
wherein remaining channels of the set of channels are not coupled to any of the first N optical connections and the second N optical connections, the remaining channels being de-activated, such that the remaining channel do not supply and do not receive light that has been modulated to carry data.

39. An apparatus in accordance with claim 38, further including:
a combiner provided on the substrate, the combiner being coupled to each of the first plurality of modulators, each of the second plurality of modulators, each of the third plurality of modulators, and each of the fourth plurality of modulators; and
a splitter provided on the substrate, the splitter being coupled to each of the first plurality of optical hybrid circuits, each of the second plurality of optical hybrid circuits, each of the third plurality of optical hybrid circuits, and each of the fourth plurality of optical hybrid circuits.

40. An apparatus, comprising:
a substrate;
N channels provided on the substrate, each of which including a corresponding one of a first plurality of lasers, N being an integer, each of the first plurality of lasers being associated with a corresponding one of a plurality of wavelengths, the plurality of wavelengths defining a band;
a spare channel provided on the substrate, the spare channel including a second laser, the second laser being tunable over a range of wavelengths, the band being within the range of wavelengths, collectively, the spare channel and the N channels being a set of channels; and
N optical connections, each of which being coupled to a respective one of a plurality of active channels, the plurality of active channels being selected from the set of channels, such that each of the plurality of active channels supplies or receives a respective one of N modulated optical signals via a corresponding one of the N optical connections, wherein a remaining channel of the set of channels is not coupled to any of the N optical connections, the remaining channel being de-activated, such that the remaining channel does not supply or receive light that has been modulated to carry data.

41. An apparatus, comprising:
a photonic integrated circuit (PIC), which includes N lasers and k spare lasers, each of the each of the k spare lasers being widely tunable, the PIC includes N channels and k spare channels, each of which including a corresponding one of the k spare lasers, N and k being integers; and
N+k optical fibers extending from the PIC; and
N optical connections, each of which being coupled to a respective one of N fibers of the N+k optical fibers, wherein each of k fibers, other than the N fibers, is coupled to a respective one of k channels of the N+k channels, each of the k channels being de-activated such that the k channels do not transmit or receive light that has been modulated to carry data.

42. An apparatus in accordance with claim 1, wherein each of the plurality of active channels supplies a respective one of the N modulated optical signals.

43. An apparatus in accordance with claim 1, wherein each of the plurality of active channels receives a respective one of the N modulated optical signals.
